(19) United States
(12) Patent Application Publication
(10) Pub. No.: US 2025/0202748 A1
(43) Pub. Date: Jun. 19, 2025

(54) REFERENCE SIGNALS FOR LOG-LIKELIHOOD RATIO SCALING ESTIMATION FOR PRE-EQUALIZED TRANSMISSIONS

(71) Applicant: QUALCOMM Incorporated, San Diego, CA (US)

(72) Inventors: Daniel PAZ, Atlit (IL); Michael LEVITSKY, Rehovot (IL); Tom BARAK, Rehovot (IL); Alexander SVERDLOV, Rehovot (IL)

(21) Appl. No.: 18/539,875

(22) Filed: Dec. 14, 2023

(51) Int. Cl. H04L 27/26

(52) U.S. Cl. CPC H04L 27/2613; H04L 27/26526

(57) ABSTRACT

Methods, systems, and devices for wireless communication are described. A wireless device may receive, from another device (e.g., a user equipment (UE)), a message indicating a configuration of a set of log-likelihood ratio (LLR) scaling reference signals. The configuration may indicate a resource allocation for the set of LLR scaling reference signals, where the resource allocation may be based on a type of waveform used for communications between the wireless device and the UE. The wireless device may receive one or more pre-equalized data transmissions having the waveform type, and the pre-equalized data transmission may include the LLR scaling reference signals in accordance with the resource allocation. The wireless device may perform measurements of the set of LLR scaling reference signals for performing LLR scaling, and the wireless device may decode the one or more pre-equalized transmissions based on the LLR scaling using the set of LLR scaling reference signals.

### FIELD OF TECHNOLOGY

The following relates to wireless communication, including reference signals for log-likelihood ratio (LLR) scaling estimation for pre-equalized transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some UEs support device-to-device communications. For example, a UE may communicate with one or more devices via a sidelink. Sidelink communications may enable direct communications between devices, such as between one or more UEs and one or more extended reality (XR) devices.

### SUMMARY

The described techniques relate to improved methods, systems, devices, and apparatuses that support reference signals for log-likelihood ratio (LLR) scaling estimation for pre-equalized transmissions. For example, the described techniques provide for a configuration of reference signals that are dedicated to LLR scaling operations at a wireless device (e.g., an extended reality (XR) device), which may be used for decoding pre-equalized data transmissions. In some aspects, the wireless device may receive, from another device (e.g., a user equipment (UE)), a message indicating a configuration of a set of LLR scaling reference signals. The configuration may indicate a resource allocation for the set of LLR scaling reference signals, where the resource allocation may be based on a type of waveform used for communications between the wireless device and the UE. The wireless device may receive one or more pre-equalized data transmissions having the waveform type, and the pre-equalized data transmission may include the LLR scaling reference signals in accordance with the resource allocation. The wireless device may perform measurements of the set of LLR scaling reference signals for performing LLR scaling, and the wireless device may decode the one or more pre-equalized transmissions based on the LLR scaling using the set of LLR scaling reference signals.

A method by a wireless device is described. The method may include receiving, from a UE, a message indicating a configuration of a set of LLR scaling reference signals, the configuration including a resource allocation for the set of LLR scaling reference signals that is based on a waveform type associated with communications between the UE and the wireless device, receiving, from the UE, one or more pre-equalized data transmissions that include the set of LLR scaling reference signals in accordance with the resource allocation, the one or more pre-equalized data transmissions having the waveform type, and decoding the one or more pre-equalized data transmissions based on LLR scaling using the set of LLR scaling reference signals.

A wireless device is described. The wireless device may include one or more memories storing processor-executable code, and one or more processors coupled with the one or more memories. The one or more processors may individually or collectively operable to execute the code to cause the wireless device to receive, from a UE, a message indicating a configuration of a set of LLR scaling reference signals, the configuration including a resource allocation for the set of LLR scaling reference signals that is based on a waveform type associated with communications between the UE and the wireless device, receive, from the UE, one or more pre-equalized data transmissions that include the set of LLR scaling reference signals in accordance with the resource allocation, the one or more pre-equalized data transmissions having the waveform type, and decode the one or more pre-equalized data transmissions based on LLR scaling using the set of LLR scaling reference signals.

Another wireless device is described. The wireless device may include means for receiving, from a UE, a message indicating a configuration of a set of LLR scaling reference signals, the configuration including a resource allocation for the set of LLR scaling reference signals that is based on a waveform type associated with communications between the UE and the wireless device, means for receiving, from the UE, one or more pre-equalized data transmissions that include the set of LLR scaling reference signals in accordance with the resource allocation, the one or more pre-equalized data transmissions having the waveform type, and means for decoding the one or more pre-equalized data transmissions based on LLR scaling using the set of LLR scaling reference signals.

A non-transitory computer-readable medium storing code is described. The code may include instructions executable by one or more processors to receive, from a UE, a message indicating a configuration of a set of LLR scaling reference signals, the configuration including a resource allocation for the set of LLR scaling reference signals that is based on a waveform type associated with communications between the UE and the wireless device, receive, from the UE, one or more pre-equalized data transmissions that include the set of LLR scaling reference signals in accordance with the resource allocation, the one or more pre-equalized data transmissions having the waveform type, and decode the one or more pre-equalized data transmissions based on LLR scaling using the set of LLR scaling reference signals.

Some examples of the method, wireless devices, and non-transitory computer-readable medium described herein may further include operations, features, means, or instructions for performing the LLR scaling for the one or more pre-equalized data transmissions, where the LLR scaling may be different for each resource element per symbol period of the one or more pre-equalized data transmissions, the waveform type of the one or more pre-equalized data transmissions including an orthogonal frequency division multiplexing (OFDM) waveform.

In some examples of the method, wireless devices, and non-transitory computer-readable medium described herein, the resource allocation for the set of LLR scaling reference signals includes a two-dimensional grid including respective resources in a time domain and a frequency domain based on the OFDM waveform.

Some examples of the method, wireless devices, and non-transitory computer-readable medium described herein may further include operations, features, means, or instructions for receiving, based on the configuration, the set of LLR scaling reference signals in accordance with the two-dimensional grid, where a density of the set of LLR scaling reference signals in the two-dimensional grid may be based on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

Some examples of the method, wireless devices, and non-transitory computer-readable medium described herein may further include operations, features, means, or instructions for performing the LLR scaling for the one or more pre-equalized data transmissions, where the LLR scaling may be different for each symbol period of the one or more pre-equalized data transmissions, the waveform type of the one or more pre-equalized data transmissions including a discrete Fourier transform-spread-orthogonal frequency division multiplexing (DFT-s-OFDM) waveform.

In some examples of the method, wireless devices, and non-transitory computer-readable medium described herein, the resource allocation for the set of LLR scaling reference signals includes a one-dimensional grid including respective resources in a time domain based on the DFT-s-OFDM waveform.

Some examples of the method, wireless devices, and non-transitory computer-readable medium described herein may further include operations, features, means, or instructions for receiving, based on the configuration, the set of LLR scaling reference signals in accordance with the one-dimensional grid, where a density of the set of LLR scaling reference signals in the time domain may be based on a range of signal-to-noise ratios, a range of modulation and coding schemes, one or more mobility parameters, one or more interference characteristics in the time domain, one or more parameters associated with nonstationary interference, or any combination thereof.

In some examples of the method, wireless devices, and non-transitory computer-readable medium described herein, the set of LLR scaling reference signals include one or more subsets of LLR scaling reference signals included in respective groups in accordance with the configuration and the LLR scaling may be based on the respective groups.

Some examples of the method, wireless devices, and non-transitory computer-readable medium described herein may further include operations, features, means, or instructions for receiving, based on the configuration, the set of LLR scaling reference signals, where the set of LLR scaling reference signals include one or more blocks of LLR scaling reference signals, each block including a repetition or concatenation of a respective LLR scaling reference signal, and each block being separated by a time-domain gap or a frequency-domain gap based on the waveform type.

Some examples of the method, wireless devices, and non-transitory computer-readable medium described herein may further include operations, features, means, or instructions for receiving, from the UE, one or more messages indicating one or more parameters associated with communicating with the UE, where the configuration of the set of LLR scaling reference signals may be based on the one or more parameters.

In some examples of the method, wireless devices, and non-transitory computer-readable medium described herein, the one or more parameters may be associated with channel Doppler effects, interference characteristics, a channel flatness, a physical resource group size, or any combination thereof.

In some examples of the method, wireless devices, and non-transitory computer-readable medium described herein, the configuration may be indicated for each component carrier of a set of component carriers associated with communication between the wireless device and the UE.

In some examples of the method, wireless devices, and non-transitory computer-readable medium described herein, receiving the message indicating the configuration may include operations, features, means, or instructions for receiving a radio resource control (RRC) message, a medium access control-control element (MAC-CE), downlink control information, or any combination thereof, indicating the configuration of the set of LLR scaling reference signals.

A method by a UE is described. The method may include transmitting, to a wireless device, a message indicating a configuration of a set of LLR scaling reference signals, the configuration including a resource allocation for the set of LLR scaling reference signals that is based on a waveform type associated with communications between the wireless device and the UE and transmitting, to the wireless device, one or more pre-equalized data transmissions that include the set of LLR scaling reference signals in accordance with the resource allocation, the one or more pre-equalized data transmissions having the waveform type.

A UE is described. The UE may include one or more memories storing processor-executable code, and one or more processors coupled with the one or more memories. The one or more processors may individually or collectively operable to execute the code to cause the UE to transmit, to a wireless device, a message indicating a configuration of a set of LLR scaling reference signals, the configuration including a resource allocation for the set of LLR scaling reference signals that is based on a waveform type associated with communications between the wireless device and the UE and transmit, to the wireless device, one or more pre-equalized data transmissions that include the set of LLR scaling reference signals in accordance with the resource allocation, the one or more pre-equalized data transmissions having the waveform type.

Another UE is described. The UE may include means for transmitting, to a wireless device, a message indicating a configuration of a set of LLR scaling reference signals, the configuration including a resource allocation for the set of LLR scaling reference signals that is based on a waveform type associated with communications between the wireless device and the UE and means for transmitting, to the wireless device, one or more pre-equalized data transmissions that include the set of LLR scaling reference signals in accordance with the resource allocation, the one or more pre-equalized data transmissions having the waveform type.

A non-transitory computer-readable medium storing code is described. The code may include instructions executable by one or more processors to transmit, to a wireless device, a message indicating a configuration of a set of LLR scaling reference signals, the configuration including a resource allocation for the set of LLR scaling reference signals that is based on a waveform type associated with communications between the wireless device and the UE and transmit, to the wireless device, one or more pre-equalized data transmissions that include the set of LLR scaling reference signals in accordance with the resource allocation, the one or more pre-equalized data transmissions having the waveform type.

Some examples of the method, UEs, and non-transitory computer-readable medium described herein may further include operations, features, means, or instructions for determining that the waveform type includes an OFDM waveform, where the resource allocation for the set of LLR scaling reference signals includes a two-dimensional grid including respective resources in a time domain and a frequency domain based on the OFDM waveform.

Some examples of the method, UEs, and non-transitory computer-readable medium described herein may further include operations, features, means, or instructions for transmitting, based on the configuration, the set of LLR scaling reference signals in accordance with the two-dimensional grid, where a density of the set of LLR scaling reference signals in the two-dimensional grid may be based on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

Some examples of the method, UEs, and non-transitory computer-readable medium described herein may further include operations, features, means, or instructions for determining that the waveform type includes a DFT-s-OFDM waveform, where the resource allocation for the set of LLR scaling reference signals includes a one-dimensional grid including respective resources in a time domain based on the DFT-s-OFDM waveform.

Some examples of the method, UEs, and non-transitory computer-readable medium described herein may further include operations, features, means, or instructions for receiving, based on the configuration, the set of LLR scaling reference signals in accordance with the one-dimensional grid, where a density of the set of LLR scaling reference signals in the time domain may be based on a range of signal-to-noise ratios, a range of modulation and coding schemes, one or more mobility parameters, one or more interference characteristics in the time domain, one or more parameters associated with nonstationary interference, or any combination thereof.

Some examples of the method, UEs, and non-transitory computer-readable medium described herein may further include operations, features, means, or instructions for transmitting, based on the configuration, the set of LLR scaling reference signals, where the set of LLR scaling reference signals include one or more blocks of LLR scaling reference signals, each block including a repetition or concatenation of a respective LLR scaling reference signal, and each block being separated by a time-domain gap or a frequency-domain gap based on the waveform type.

Some examples of the method, UEs, and non-transitory computer-readable medium described herein may further include operations, features, means, or instructions for determining one or more parameters associated with communicating with the wireless device, where the configuration of the set of LLR scaling reference signals may be based on the one or more parameters and transmitting, to the wireless device, one or more messages indicating the one or more parameters.

In some examples of the method, UEs, and non-transitory computer-readable medium described herein, the one or more parameters may be associated with channel Doppler effects, interference characteristics, a channel flatness, a physical resource group size, or any combination thereof.

In some examples of the method, UEs, and non-transitory computer-readable medium described herein, the configuration may be indicated for each component carrier of a set of component carriers associated with communication between the wireless device and the UE.

In some examples of the method, UEs, and non-transitory computer-readable medium described herein, transmitting the message indicating the configuration may include operations, features, means, or instructions for transmitting an RRC message, a MAC-CE, downlink control information, or any combination thereof, indicating the configuration of the set of LLR scaling reference signals.

### BRIEF DESCRIPTION OF THE DRAWINGS

FIG. 1 shows an example of a wireless communications system that supports reference signals for log-likelihood ratio (LLR) scaling estimation for pre-equalized transmissions in accordance with one or more aspects of the present disclosure.

FIG. 2 shows an example of a wireless communications system that supports reference signals for LLR scaling estimation for pre-equalized transmissions in accordance with one or more aspects of the present disclosure.

FIGS. 3, 4, 5A, and 5B show examples of resource grids that support reference signals for LLR scaling estimation for pre-equalized transmissions in accordance with one or more aspects of the present disclosure.

FIG. 6 shows an example of a process flow that supports reference signals for LLR scaling estimation for pre-equalized transmissions in accordance with one or more aspects of the present disclosure.

FIGS. 7 and 8 show block diagrams of devices that support reference signals for LLR scaling estimation for pre-equalized transmissions in accordance with one or more aspects of the present disclosure.

FIG. 9 shows a block diagram of a communications manager that supports reference signals for LLR scaling estimation for pre-equalized transmissions in accordance with one or more aspects of the present disclosure.

FIG. 10 shows a diagram of a system including a device that supports reference signals for LLR scaling estimation for pre-equalized transmissions in accordance with one or more aspects of the present disclosure.

FIGS. 11 and 12 show block diagrams of devices that support reference signals for LLR scaling estimation for pre-equalized transmissions in accordance with one or more aspects of the present disclosure.

FIG. 13 shows a block diagram of a communications manager that supports reference signals for LLR scaling estimation for pre-equalized transmissions in accordance with one or more aspects of the present disclosure.

FIG. 14 shows a diagram of a system including a device that supports reference signals for LLR scaling estimation for pre-equalized transmissions in accordance with one or more aspects of the present disclosure.

FIGS. 15 through 20 show flowcharts illustrating methods that support reference signals for LLR scaling estimation for pre-equalized transmissions in accordance with one or more aspects of the present disclosure.

### DETAILED DESCRIPTION

Extended reality (XR) is a technology with potential to become a leading product in the personal electronics segment in the next decade. In some examples, XR technology may include augmented reality (AR) technologies, virtual reality (VR) technologies, mixed reality (MR) technologies, among other examples. XR technology, however, still faces several challenges to be addressed before achieving increased commercialization and market penetration. Some of the challenges may include weight, processing complexity, and power consumption. For example, constrained battery weight, processing complexity, and power consumption provide significant challenges in view of the relatively heavy processing demands of some XR applications and services.

In some systems, an XR device may employ a processing/functionality split with a user equipment (UE) (or another device). In such cases, transmit and receive processing complexity (e.g., physical layer-related and/or modem-related processing) may be shifted to the UE, for example, via a sidelink communication link. In such cases, performing transmit pre-equalization or precoding on the UE transmit side may reduce receive complexity and power consumption of the XR device, while enabling similar throughput or performance, without significant degradation, relative to receive-side equalization approaches. That is, “pre-equalization,” as used herein, may refer to a technique of processing a signal before it passes through a channel to reduce or eliminate inter-symbol interference (ISI) and/or to improve channel characteristics. In some approaches, pre-equalization may rely on channel state information obtained by channel estimation processes and knowledge of the channel at the transmitting device. Further techniques, for example, in addition to pre-equalization, may be desirable to further reduce complexity and power consumption at the XR device.

Techniques described herein may enhance XR device performance by offloading processing operations from an XR device to a companion UE (or other device). In some examples, the XR device may receive pre-equalized transmissions from the UE, and the XR device may calculate log-likelihood ratio (LLR) scaling for the received signal and based on reference signals from the UE. In such cases, the LLR scaling output may be used as an input to a relatively low-complexity decoding scheme at the XR device. As such, the XR device may receive an indication of a configuration for reference signals dedicated to LLR scaling measurements (e.g., referred to as LLR scaling reference signals) that are included in pre-equalized data transmissions from the UE. The configuration may include one or more resource allocations for the LLR scaling reference signals based on a type of waveform (e.g., an orthogonal frequency-division multiplexing (OFDM) waveform, a discrete Fourier transform spread orthogonal frequency division multiplexing (DFT-S-OFDM) waveform, among other examples) associated with communications between the UE and the XR device. In some aspects, the configuration of the LLR scaling reference signals may indicate some density of the LLR scaling reference signals included in the data transmission, where the density of the reference signals may be based on operational signal characteristics (e.g., signal-to-noise ratio (SNR), modulation and coding scheme (MCS)), mobility of the XR device, a channel flatness, a channel type, interference characteristics, and/or nonstationary interference, among other examples). In some examples, the LLR scaling reference signals may be associated with two or more reference signal groups (e.g., pilot groups), and the reference signals may be further allocated to blocks of concatenated reference signals.

Aspects of the disclosure are initially described in the context of wireless communications systems. Aspects of the disclosure are additionally described with reference to resource grids, process flows, and block diagrams. Aspects of the disclosure are further illustrated by and described with reference to apparatus diagrams, system diagrams, and flowcharts that relate to reference signals for LLR scaling estimation for pre-equalized transmissions.

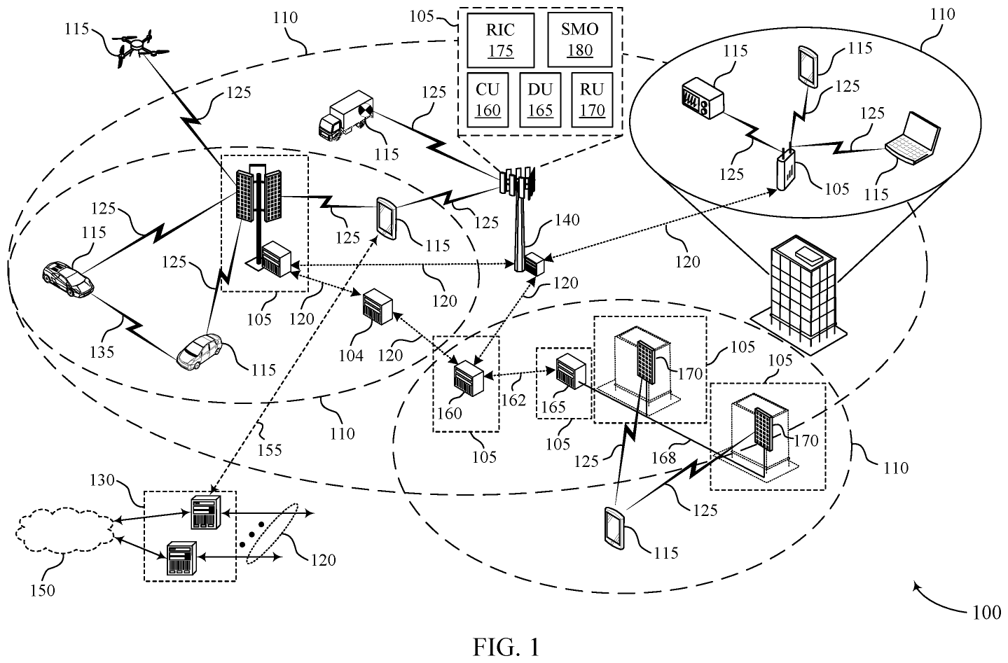

FIG. 1 shows an example of a wireless communications system 100 that supports reference signals for LLR scaling estimation for pre-equalized transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reference signals for LLR scaling estimation for pre-equalized transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Extended reality (XR) devices are a promising field of development in technology. XR devices may incorporate a variety of sensors (e.g., cameras) and applications that rely on heavy processing. Additionally, XR devices may be highly mobile and may be affected by increasing signal complexity. However, XR devices, may not be well equipped to process large amounts of data or complex signaling due to practical weight, heat, and power limitations. For example, XR glasses or goggles may have a weight limit and have a form factor with relatively low surface area (e.g., proportionally small surface size) for dissipating heat. Low heat dissipation abilities may limit power consumption, for example, to only a few Watts. XR devices may thus be limited to smaller batteries and lower processing capabilities. These limitations may mean that a standalone XR product may be limited to some specific applications/static and short time usage scenarios which assume a higher form factor (e.g., head mounted device (HMD)) usage, which may be inconvenient. As a result, it may be desirable to offload (or split) aspects of processing wireless signals from the XR device to another, companion device (such as a UE 115). Such techniques may include pre-equalizing a signal that is transmitted to the XR device, which may reduce decoding complexity. However, splitting may not improve XR capabilities sufficiently to support more demanding (e.g., premium) XR applications (e.g., frames per second (fps) higher than 120 Hz, video formats more than 8k). Although splitting may reduce power consumption by the XR device, additional techniques to improve decoding efficiency may be desirable.

As described herein a wireless device (e.g., an XR device) may offload processing operations to a companion (e.g., connected, associated) UE 115 to enhance the performance of the XR device. In some examples, the XR device may receive pre-equalized transmissions from the UE 115, and the XR device may calculate LLR scaling for the received signal and based on dedicated reference signals from the UE. In such cases, the LLR scaling output may be used as an input to a low-complexity decoding scheme at the XR device. As such, the XR device may receive an indication of a configuration for reference signals dedicated to LLR scaling measurements (e.g., referred to as LLR scaling reference signals) that are included in pre-equalized data transmissions from the UE 115. The configuration may include one or more resource allocations for the LLR scaling reference signals based on a type of waveform (e.g., an OFDM waveform, a DFT-s-OFDM waveform) associated with communications between the UE 115 and the XR device. Further, the configuration of the LLR scaling reference signals may indicate some density of the reference signals included in the data transmission. The density of the reference signals may be based on operational signal characteristics (e.g., SNR, MCS), a range of modulation and coding schemes, mobility of the XR device (e.g., mobility parameters, a mobility state), channel flatness, one or more channel types, physical resource group (PRG) size, one or more interference characteristics in the frequency domain, one or more interference characteristics in the frequency domain, and/or one or more characteristics associated with nonstationary interference, among other examples. The XR device offloading processing to the UE 115 may improve processing and increase performance for XR device while allowing a lightweight battery, longer battery lifetime, reduced heat generation, portability and satisfying other limitations. This may allow XR devices to more broadly enter commercialization, penetrate markets, and undergo widespread usage (e.g., comparable with smartphones, smart watches, wireless earbuds, or the like).

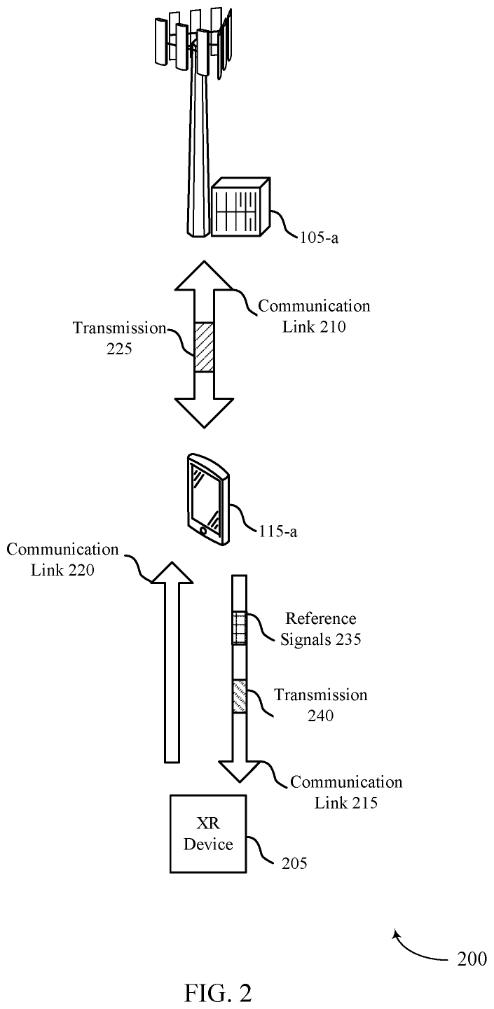

FIG. 2 shows an example of a wireless communications system 200 that supports reference signals for LLR scaling estimation for pre-equalized transmissions in accordance with one or more aspects of the present disclosure. The wireless communications system 200 may implement or may be implemented by aspects of the wireless communications system 100. For example, the wireless communications system 200 may include a UE 115 (e.g., a UE 115-a) an XR device 205 (e.g., a wireless device), and a network entity 105 (e.g., a network entity 105-a), which may be examples of the corresponding devices as described with reference to FIG. 1. The XR device 205 (e.g., AR glasses) may connect to the UE 115-a (e.g., a smartphone or a “puck”) via Wi-Fi-D or a 5G sidelink, among other technologies. The UE 115-a may connect to the network entity 105 (e.g., gNB) via 5G NR. The network entity 105 may be connected to an edge or cloud via the Internet.

In some wireless communications systems, a UE 115-a may communicate with a network entity 105-a via a communication link 210. For example, the UE 115-a may receive downlink transmissions 225 from the network entity 105-a and transmit uplink transmissions 225 to the network entity 105-a via the communication link 210. In some examples, the communication link 210 may be an uplink or downlink channel (e.g., a 5G uplink or downlink channel). The UE 115-a may communicate data with an edge device (e.g., a cloud server) via the network entity 105-a. The UE 115-a may, additionally, or alternatively, communicate with an XR device 205 (XR glasses, goggles, or the like) via a communication link 215 and a communication link 220. For example, the UE 115-a may receive transmissions from the XR device 205 via the communication link 220, and may transmit transmissions to the XR device 205 via the communication link 215. The communication link 220 and the communication link 215 may be examples of sidelink communications links such as 5G sidelink channels, Wi-Fi links, Bluetooth communication links, P2P or D2D links, or any other communications links capable of supporting communications between UE 115-a and XR device 205.

In some examples, the XR device 205 may have weight, processing, power consumption, or heat dissipation constraints or limitations (e.g., to allow for long-time or on-the-go use by a user of the XR device 205). For example, the XR device 205 may have a weight similar to non-XR glasses (e.g., about 30-40 grams), and may accordingly include light weight components, such as light weight batteries. Further, a heat dissipation ability of the XR device 205 may be proportional to a surface size of the XR device 205. Thus, the XR device may have a relatively smaller heat dissipation ability as compared to other UEs 115, which may have a larger surface size or area than the XR device 205. In some examples, a power consumption limit associated with the heat dissipation ability of the XR device 205 may be smaller than for the other UEs 115 (e.g., a limit of between 1.5 and 3 Watts). Accordingly, to reduce heat generation and power consumption, the XR device 205 may operate with a limited processing complexity, which may allow for a lighter-weight XR device 205 and a longer battery lifetime.

Some XR devices 205 (e.g., a relatively higher form factor HMD) may support multiple XR applications and/or may be used for specific applications (e.g., static and short time usage scenarios). That is, HMD devices may allow for relatively higher processing complexity, but may be inconvenient for relatively longer time usage or mobile scenarios, in some cases.

Accordingly, to allow for reduced processing complexity associated with smaller and lighter-weight XR devices 205, some XR-related processing may be shifted to (performed by, transferred to) a companion device such as the UE 115-a, which may be referred to as a split XR approach. In some split XR approaches, the UE 115-a may perform rendering-related processes (e.g., video rendering), while the XR device 205 may include processing components for different edge-to-edge (E2E) considerations (e.g., photo-to-motion latency considerations, XR to companion device wireless link capacity, communication link power consumption for long range links). Thus, the power consumption involved in such split XR approaches may exceed the power consumption limit of the XR device 205 even in relatively less demanding or relatively lower complexity scenarios. Further, such split XR approaches may not be capable of supporting demanding or premium XR applications (e.g., greater than 120 fps, 8K high-resolution video formats).

For example, some split XR approaches may use long-range communication links over a licensed spectrum shared with multiple served XR users. However, such approaches may involve tight (e.g., restricted, limited) scheduling and staggering, and may result in a limited capacity per XR user. Accordingly, the XR device 205 may include one or more sensors which may perform local data processing (e.g., to reduce a volume of data such as six degree of freedom (DOF) tracking, eye tracking for field of view (FOV) derivation, or the like, transmitted to the companion device). Further, additional data transmitted from the XR device 205 to the companion device (e.g., sensor and camera data) and from the companion device to the XR device 205 (e.g., rendered video data) may be compressed with a high compression factor to achieve a link capacity threshold per XR user. Such data pre-processing and video compression with a sufficiently high compression factor (e.g., high profile of H264) may involve a high processing complexity for an encoding device. Further, such techniques may involve a relatively high double data rate (DDR) usage for transmission and reception path video processing, which may result in increased power consumption by the XR device 205. Additionally, to account for latencies such as photon-to-motion latency and network entity-based split latencies, the XR device 205 may apply asynchronous time wrapping (ATW) as part of receiver-side processing for last moment image alignment with a pose associated with the user. Accordingly, such techniques may result in power consumption which exceeds the power consumption limit (e.g., greater than 3 Watts).

Some other split XR approaches may use processing offloading techniques. For example, the XR device 205 may have a tethering link (e.g., the communication link 215, the communication link 220) with the companion device (e.g., the UE 115-a) which may be relatively shorter than the long-range communication links. Such approaches may involve a similar processing load as the long-range communication link techniques, but may reduce modem-related power consumption as compared to the long range communication link techniques. However, such approaches may result in power consumption which exceeds the power consumption limit.

Some techniques may allow for relatively more processing offloading from the XR device 205 to the UE 115-a (e.g., and the network entity 105-a) such that the XR device 205 may generally operate as an input/output (I/O) device. For example, the XR device 205 may share local sensor information with the UE 115-a without performing pre-processing, and the XR device 205 may receive rendered video from the UE 115-a to be displayed to the user without any post-processing. Such techniques may allow for the XR device 205 to significantly reduce power consumption as compared to other split XR approaches (e.g., by about 50%), which may allow for lower power and lighter weight XR devices 205 (e.g., which may achieve target XR characteristics or key performance indicator (KPI) thresholds).

To allow for the XR device 205 to operate as a mostly I/O device, as described herein, complexity associated with the XR device 205 transmitting or receiving signaling (e.g., including PHY layer or modem related complexity) may be shifted to (performed by) the UE 115-a. In some examples, the modem complexity may result from receiver-side processing. Accordingly, receiver PHY modules at the XR device 205 may be effectively shifted to the transmission side of the communication link 215 at the UE 115-a (e.g., and thus degenerated at the XR device 205). Thus, the XR device 205 may operate with reduced processing by the XR mode, and may accordingly achieve a reduced processing complexity and power consumption. To perform such techniques, the UE 115-a may have a quasi-continuous (e.g., fixed or slow changing) channel state information (CSI) knowledge for the channel (e.g., with or without channel reciprocity), which may be achieved using transmission schemes such as low latency time division duplex (TDD), full duplex, or subband full-duplex (SBFD). In some examples, full duplex schemes may be implemented for low power, short range communication links such as the communication link 215 and the communication link 220 relatively easier than for ultra-wideband (UWB) links.

UWB (e.g., frequency range of 7-10 GHz) may have a relatively high probability for significant interference. This interference may be due to multiple sources such as UWB standard compliant devices (e.g., IEEE 802.15.4z), satellite antennas and radars, government and military service transmissions, future 5G or 6G license services, and Wi-Fi and cellular masks that extend into the band of the XR device 205. These interference sources may be dynamic and unpredictable and may degrade the performance of the link between the XR device 205 and the UE 115-a for periods of time. While the performance of the link is degraded, the link capacity may degrade, and quality of service may decrease. However, various waveform and link design considerations may account for the interference and provide reasonable interference resiliency.

In some examples, the XR device 205 may perform receiver-side equalization to account for interference and poor channel quality, which may increase modem related complexity for the XR device 205. Accordingly, to further reduce complexity for the XR device 205, the UE 115-a may perform processing associated with receiver-side equalization. That is, the UE 115-a may apply a transmission-side pre-equalization to account for the interference (e.g., instead of post-equalization applied by the XR device 205). Such techniques may result in approximately the same (e.g., or improved) performance as receiver-side equalization.

In some examples, if channel reciprocity holds (e.g., for single frequency full duplex (SFFD) and TDD communications), the UE 115-a may perform channel estimation for both directions of the channel (e.g., from the UE 115-a to the XR device 205 and from the XR device 205 to the UE 115-a) by measuring reference signals transmitted by the XR device 205 to the UE 115-a. In some other examples, if channel reciprocity does not hold (e.g., for SBFD or FDD communications), the XR device 205 may signal or indicate CSI information to the UE 115-a. That is, to support the UE 115-a performing pre-equalization, the UE 115-a may acquire receiver-side noise statistics (Rnn) from the XR device 205 for use in a pre-equalization process. During a channel estimation and a Rnn estimation process, the Rnn may capture interference induced noise. For example, the UE 115-a may use the Rnn from the XR device 205 to apply the inverse of the Rnn on a received signal (e.g., whitening) as part of the equalization process or before the equalization process (e.g., during the pre-equalization process).

However, to shift processing from the XR device 205 to the UE 115-a, the XR device 205 may refrain from performing space-frequency equalization or channel estimations. That is, for pre-equalized downlink transmissions, noise whitening at the transmitting or the receiving side may not be able to be employed, as may be done with a standard receiving architecture. In some examples, noise whitening may not be able to be applied on the transmitting side as part of the pre-equalization process if the interference is non-stationary. That is, a channel estimation that is estimated based on a previous downlink reference signal transmission (samples of non-pre-equalized downlink references signals may be indicated back from the receiving side to the transmitting side) and used to derive the transmitted pre-equalization matrix for the subsequent slots, may not be able to account for any nonstationary instant interference that may occur on these subsequent downlink transmission slots. In some examples, noise whitening (e.g., noise rejection) may not be able to be applied on the transmitting side autonomously since whitening effectively adds to the channel response and this whitening addition may not be accounted for by the transmitted pre-equalization if the interference is not stationary. In other words, if the XR device 205 were to perform noise whitening, the XR device 205 may “break” the pre-equalization transmission. Additionally, noise whitening by the receiving side may be undesirable due to a focus on reducing processing done by the receiving side. Further, capturing the interference at the receiving side via estimation of the Rnn matrix to apply noise whitening may use frequency- and time-selective noise estimation (e.g., UWB interference may not align in time and in frequency to the XR sidelink) which may require relatively increased pilot signal overhead and additional signaling.

As described herein, to reduce processing performed by the XR device, the XR device 205 may apply LLR scaling to a transmission from the UE 115-a. In some examples, the XR device 205 may transmit a capability message to the UE 115-a indicating a capability of the XR device 205 to perform LLR scaling estimation. The UE 115-a may transmit a set of reference signals 235 to the XR device 205 such that the XR device 205 may measure the reference signals 235 and generate the one or more LLR scaling coefficients. In some examples, the UE 115-a may equalize the reference signals 235 using a pre-equalization matrix. The reference signals 235 may be reference signals that are dedicated for LLR scaling estimation (e.g., LLR scaling reference signals). The XR device 205 may use the one or more LLR scaling coefficients to decode a transmission 240 from the UE 115-a.

The LLR scaling may allow the XR device 205 to respond to instant interference (e.g., capture a nonstationary frequency and time selective interference). The LLR scaling may be measured or estimated at the XR device 205 based on one or more dedicated pre-equalized downlink reference signals. An LLR may be calculating according to Equation 1:

$${LLR}_{{b}_{i}} = \frac{1}{γ} ( min ( {\vert y - {S}_{j}^{1} \vert}^{2} ) - min ( {\vert y - {S}_{j}^{0} \vert}^{2} ) ) \qquad ( 1 )$$

where y represents the received signal, S represents the entire constellation and Sⱼ¹ and Sⱼ⁰ each represent a subset of S where the j-bit is equal to 1 or 0, and 1/γ represents the LLR scaling. The LLR scaling may be a set of coefficients proportional to the post-processing SNR (e.g., per resource element, per layer in MIMO OFDM) and may be used to increase or decrease the confidence expressed by the non-scaled LLR values. Non-scaled LLR values may rely on Euclidean distances for an equalized signal (e.g., soft symbol) with respect to expected constellation points. In other words, an LLR may be a metric that describes the probability that a bit will be zero or one. LLR values may be soft values, where LLR values may not only represent a zero or a one, but also something in-between. For example, an LLR value may signify that a bit has an 80% probability of being a one and a 20% probability of being a zero. In some examples, a very negative LLR value may signify a high probability that a bit is zero.

The LLR values may be input into a channel decoder in the XR device 205. The channel decoder may scale the LLR values with the LLR scaling coefficients which may increase or decrease confidence in the LLR values. LLR scaling may depend on the noise in the wireless communications system 200. If the wireless communications system 200 is very noisy, then there may not be much confidence in the LLR values and the LLR values may be scaled down by the LLR scaling to be smaller in magnitude. If the wireless communications system 200 has low noise, then the LLR value may be scaled up (e.g., to a higher magnitude) via the LLR scaling.

The XR device 205 may receive, from the UE 115-a, one or more parameters associated with communicating with the UE 115-a (e.g., waveform type, channel Doppler effects, interference characteristics, a channel flatness, a physical resource group size, or the like). The XR device 205 may receive one or more messages indicating the parameters associated with communicating with the UE 115-a. The reference signals may be based on the parameters.

Different allocations and processing considerations related to LLR scaling reference signals may be used for different types of data waveforms, different channel conditions, and different interference characteristics. For example, different types of data waveforms may determine whether a pilot (e.g., LLR scaling reference signal) is allocated with a one-dimensional grid (time domain) or a two-dimensional grid (both time domain and frequency domain).

Using locally-measured LLR scaling may avoid overhead associated with signaling pre-calculated LLR scaling coefficients from the UE 115-a (e.g., transmitting side) to the XR device 205 (e.g., the receiving side). Measured LLR scaling (e.g., via post processing SNR, error vector magnitude (EVM), mean square error (MSE), or the like) may reduce degradation associated with channel mismatch (e.g., channel aging under Doppler, channel mismatches related to PRG-based resolution of pre-equalization transmissions, CSI errors, and the like). This may result in increased robustness for pre-equalization transmission schemes.

Additionally, the XR device 205 offloading noise processing to the UE 115 may improve processing and increase performance for XR device 205 while allowing a lightweight battery, longer battery lifetime, reduced heat generation, portability and satisfying other limitations.

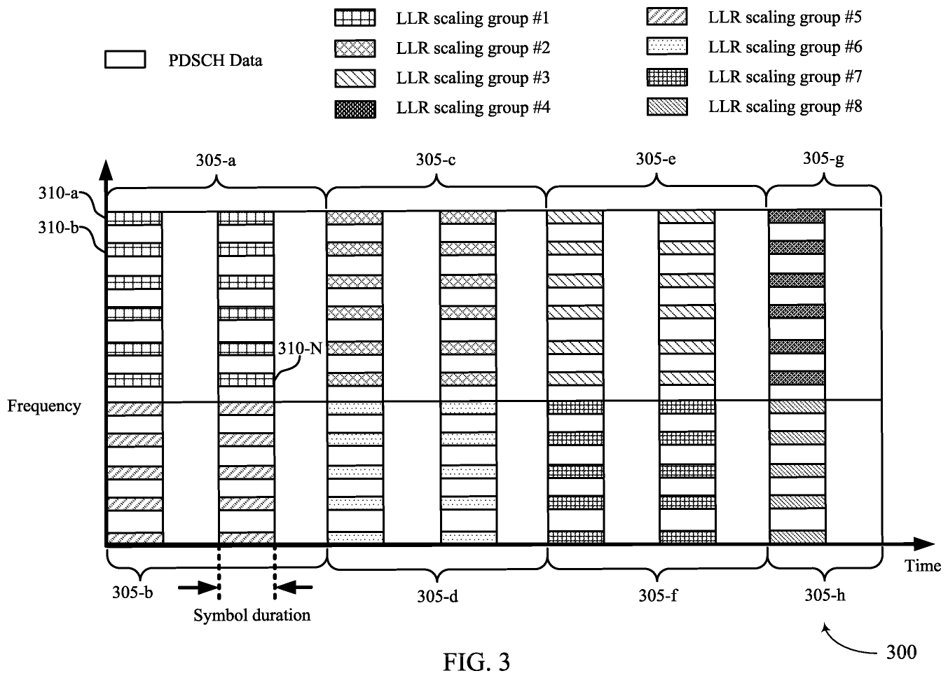

FIG. 3 shows an example of a resource grid 300 that supports reference signals for LLR scaling estimation for pre-equalized transmissions in accordance with one or more aspects of the present disclosure. The resource grid 300 may be an example of a resource grid used in a wireless communications system, such as in wireless communications system 100 or wireless communications system 200 (e.g., for sidelink communication between UE 115-a and XR device 205).

The resource grid 300 may be an example of a two-dimensional resource grid comprising resource groups 305 in a time domain and a frequency domain. Each resource group 305 (e.g., pilot group) may correspond to a portion of the resource grid 300 that contains physical data shared channel (PDSCH) data, reference signals 310, or both. There may be any quantity of resource groups 305 within the resource grid 300, although an example of eight resource groups 305 (resource groups 305-a, 305-b, 305-c, 305-d, 305-e, 305-f, 305-g, and 305-h) are shown. Additionally, there may be any quantity of reference signals 310 (reference signals 310-a, 310-b, . . . 310-N) within a respective resource group 305, although twelve reference signals 310 are shown, for example, in resource group 305-a. An LLR scaling group may refer to the set of reference signals 310 within a resource group 305 that is used to calculate LLR scaling for PDSCH data in that resource group 305. Each resource group 305 may span any quantity of time domain symbol durations (e.g., OFDM symbol durations). Resource group 305-a spans four time domain symbol durations, as an example. Resource group 305-g spans two time domain symbol durations, as another example. Each resource group 305 may span any portion of the frequency domain. As an example, each resource group 305 spans approximately half of the bandwidth shown.

LLR scaling reference signal allocation may be waveform dependent and may adhere to a sparse time-domain resource grid (e.g., in the case of DFT-S-OFDM downlink waveform) or a sparse two-dimensional frequency-domain and time-domain grid (e.g., in the case of OFDM downlink waveform). For pre-equalized transmissions (e.g., downlink transmissions, sidelink transmissions) using an OFDM waveform, LLR scaling may be different per resource element per OFDM symbol. A two-dimensional grid may be used for the addressed reference signal allocation. The quality of the LLR scaling may be associated with the organization of the resource grid 300 (e.g., organization of resource groups 305 and reference signals 310 and of the density of the resources). For example, a larger quantity of resource groups 305 may result in a higher quality of LLR scaling. Each resource element may have its own LLR scaling (e.g., LLR scaling may be performed per RE per OFDM symbol).

Resource elements for reference signals 310 may be organized into resource groups 305 on the XR device side (e.g., the receiving side), such that averaging during post processing EVM on pilot resource elements may be performed on a resource group 305 and may be applied across the data resource elements within the resource group 305 boundaries. The resource groups 305 may be configured to spread reference signals across the resource grid 300 such that there are gaps (e.g., in frequency, in time, in both) between reference signals 310. A density of the reference signals in the resource grid 300 in both frequency domain and time domain may depend on multiple factors. For example, operational SNR or MCS subrange may determine a sensitivity (e.g., accuracy) of signals to LLR scaling and how a residual equalization error across different resource elements may vary. User mobility (e.g., the Doppler effect) may determine channel aging related differences or equalization errors across different symbols or slots. Channel flatness or type and the PRG size used may determine channel mismatch and related equalization errors across different resource elements. Time resources and frequency resources occupied by a known pattern of interference may be captured more accurately via LLR scaling. Side information regarding a nonstationary interference presence (e.g., an activity or power level) may also affect the density of the resource grid 300.

The reference signal configuration within the resource grid 300 may be configured for the XR device by the UE based on one or more supported density configurations in the time domain and in the frequency domain, depending on various factors (e.g., operational SNR/MCS subrange, user mobility, channel flatness, channel type, used PRG size, known interference characteristics, side information, or the like). The configuration of the reference signals may be done semi-statically via RRC or dynamically via a synchronous configuration signaling option (e.g., medium access control-control element (MAC-CE), downlink control information (DCI)).

The XR device associated with the resource grid 300 may use the reference signals 310 within a resource group 305 to estimate the noise characteristics of that resource group 305. The XR device may derive one or more LLR scaling factors from the reference signals 310 within the resource group 305 and apply the one or more LLR scaling factors to signals (e.g., data transmissions) within the resource group 305. In other words, the LLR scaling factor derived from the reference signals 310 may be applied to PDSCH messages that include data. The calculation of the LLR scaling of the reference signals 310 may result in relatively improved EVM.

The resource grid 300 may assist the XR device in offloading processing to the UE 115. By reducing the amount of processing that the XR device performs, the overall processing and performance for the XR device may be improved while allowing a lightweight battery, longer battery lifetime, reduced heat generation, portability and satisfying other limitations.

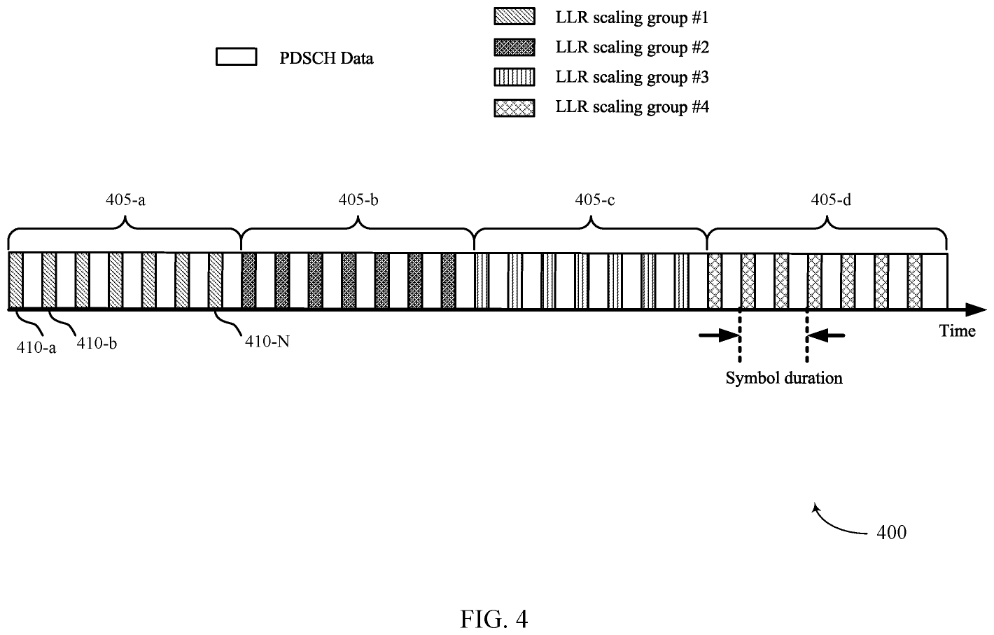

FIG. 4 shows an example of a resource grid 400 that supports reference signals for LLR scaling estimation for pre-equalized transmissions in accordance with one or more aspects of the present disclosure. The resource grid 400 may be an example of the resources used in a wireless communications system, such as in wireless communications system 100 or wireless communications system 200 (e.g., for sidelink communication between UE 115-a and XR device 205).

The resource grid 400 may be an example of a one-dimensional resource grid comprising separate resource groups 405 in the time domain. Each resource group 405 (e.g., pilot group) may correspond to an area of the resource grid 400 that contains PDSCH data, reference signals 410, or both. There may be any quantity of resource groups 405 within the resource grid 400, although an example of four resource groups 405 (resource groups 405-a, 405-b, 405-c, and 405-d) are shown. Additionally, there may be any quantity of reference signals 410 (reference signals 410-a, 410-b, . . . 410-N) within a respective resource group 405, although seven reference signals 310 are shown, for example, in resource group 405-a. An LLR scaling group may refer to the set of reference signals 410 within a resource group 405 that are used to calculate LLR scaling for the PDSCH data in that resource group 405. Each resource group 405 may span any quantity of time domain symbols (e.g., OFDM symbol durations). Resource group 405-a spans about three time-domain symbols, as an example.

An LLR scaling reference signal allocation may be waveform dependent and may adhere to a sparse time-domain resource grid (e.g., in the case of single-carrier (SC) waveforms, such as a DFT-s-OFDM downlink waveform,). For pre-equalized downlink transmissions using a DFT-s-OFDM waveform or SC waveform, LLR scaling may be different per different time-domain symbols. A one-dimensional grid may be used for the reference signal allocation in such cases. The difference between time domain symbols may be based on cumulative intra- or inter-slot Doppler impact or channel aging, or on asynchronous or random interference time and duration. The quality of the LLR scaling may be associated with the organization of the resource grid 400 (e.g., organization of resource groups 405 and reference signals 410 and of the density of the resources). For example, a relatively larger quantity of resource groups 405 may result in a relatively higher quality of LLR scaling. Each time-domain symbol may have its own LLR scaling (e.g., LLR scaling may be performed per OFDM symbol).

Resource elements of reference signals 410 may be grouped into resource groups 405 on the XR device side (e.g., the receiving side), such that averaging during post processing EVM on pilot resource elements may be performed on a resource group 405 and may be applied across the data resource elements within the resource group 405 boundaries. The resource groups 405 may be configured to spread reference signals 410 across the resource grid 400 such that the reference signals 310 have gaps between them (e.g., in frequency, in time, in both). A density of the reference signals in the resource grid 400 in the time domain may depend on multiple factors. For example, operational SNR or MCS subrange may determine a sensitivity (e.g., accuracy) of signals to LLR scaling. User mobility (e.g., the Doppler effect) may determine channel aging related differences or equalization errors across different symbols or slots. Time resources and frequency resources occupied by a known pattern of interference may be captured more accurately via LLR scaling. Side information regarding a nonstationary interference presence (e.g., an activity or power level) may also affect the density of the resource grid 400.

The reference signal 410 configuration within the resource grid 400 may be configured for the XR device by the UE based on one or more supported density configurations in the time domain and in the frequency domain, depending on various factors (e.g., operational SNR/MCS subrange, user mobility, known interference characteristics, side information, or the like). The configuration of the reference signals 410 may be done semi-statically via RRC or dynamically via a synchronous configuration signaling option (e.g., MAC-CE, DCI).

The XR device associated with the resource grid 400 may use the reference signals 410 within a resource group 405 to estimate the noise characteristics of that resource group 405. The XR device may derive one or more LLR scaling factors from the reference signals 410 within the resource group 405 and apply the one or more LLR scaling factors on signals (e.g., data transmissions) within the resource group 405. In other words, the LLR scaling factor derived from the reference signals 410 may be applied to PDSCH messages that include data.

For UWB, different LLR scaling may be configured for different carrier components. For example, some carrier components may contain interference (e.g., known narrow band interference) that is specific to that carrier component. In other words, one carrier component may contain interference that other carrier components do not contain. Accordingly, LLR scaling configurations may be calculated for a given carrier component (e.g., for very high bandwidths, for UWB).

The resource grid 400 may assist the XR device in offloading processing to the UE 115. By reducing the amount of processing that the XR device performs, the overall processing and performance for the XR device may be improved while allowing a lightweight battery, longer battery lifetime, reduced heat generation, portability and satisfying other limitations.

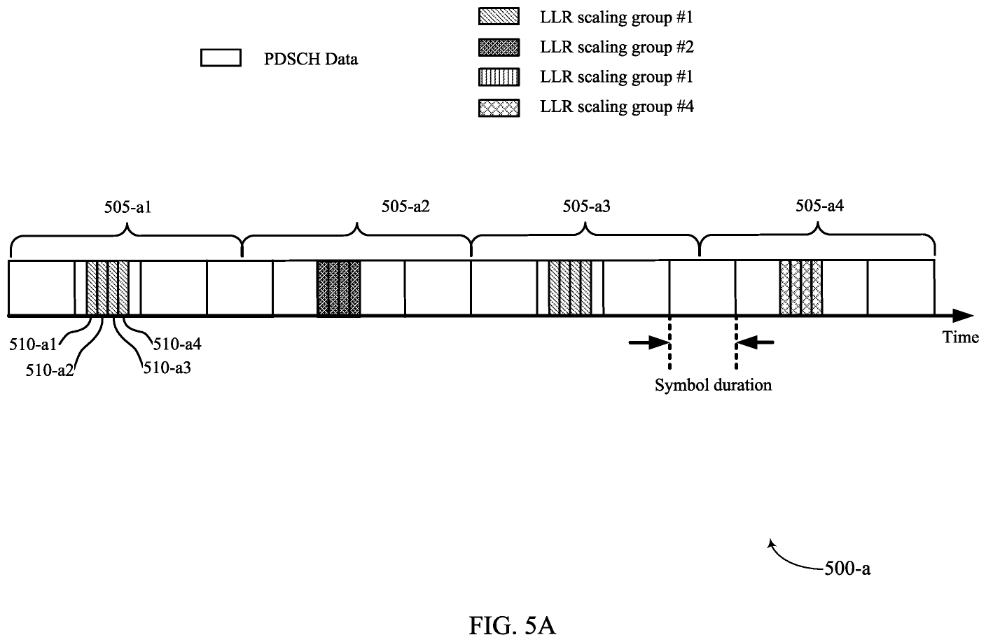

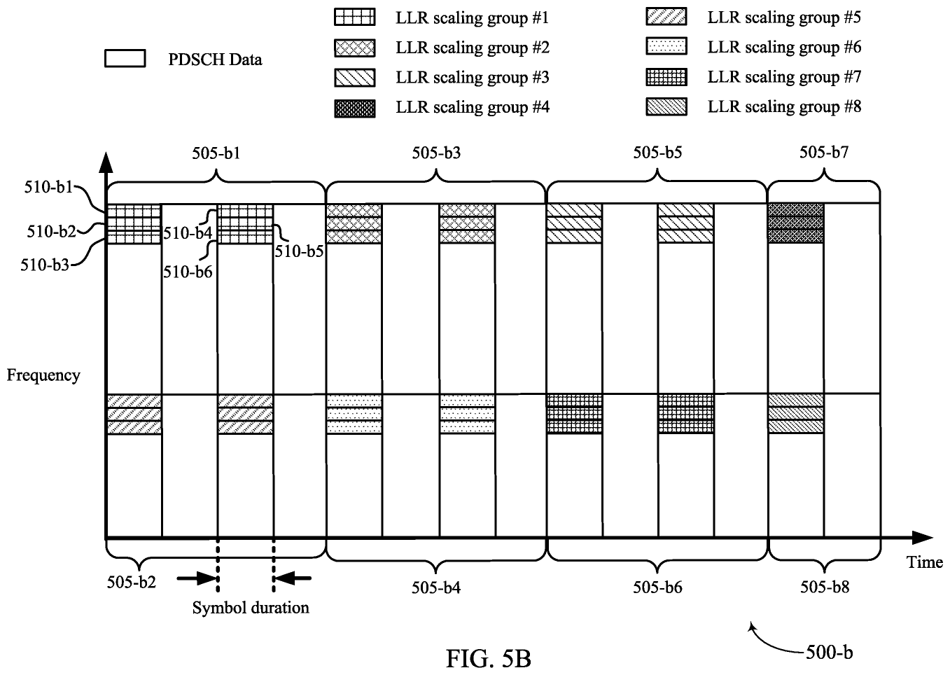

FIGS. 5A and 5B show examples of resource grid 500-a and resource grid 500-b, respectively, that support reference signals for LLR scaling estimation for pre-equalized transmissions in accordance with one or more aspects of the present disclosure. The resource grid 500-a and the resource grid 500-b may be examples of resource grids used in a wireless communications system, such as in wireless communications system 100 or wireless communications system 200 (e.g., for sidelink communication between UE 115-a and XR device 205). In some cases, reference signals 505 may be separated with some gap (e.g., in frequency, in time, in both) between each other reference signal 505. In some cases, reference signals 505 may be clustered together with some gap (e.g., in frequency, in time, in both) between the clusters. Concatenated pilots or repetitions may be applicable in the frequency domain, in the time domain, or both based on the waveform associated with communications between devices (e.g., between a UE and an XR device).

In FIG. 5A, the resource grid 500-a may be an example of a resource grid used for communication via DFT-s-OFDM waveforms. In some aspects, the resource grid 500-a may be an example of a resource grid used for communication via SC waveforms. The resource grid 500-a may be split into resource groups 505-a. Each resource group 505-a may correspond to a portion of the resource grid 500-a that contains PDSCH data, reference signals 510-a, or both. There may be any quantity of resource groups 505-a within the resource grid 500-a, although four resource groups 505-a (resource groups 505-a1, 505-a2, 505-a3, and 505-a4) are shown. Additionally, there may be any quantity of reference signals 510-a within a resource group 505-a, although four reference signals 510-a (reference signals 510-a1, 510-a2, 510-a3, and 510-a4) are shown, for example, in resource group 505-a1. Each resource group 505-a may contain a repetition or concatenation of reference signals 510-a (e.g., pilot signals). An LLR scaling group may refer to the set of reference signals 510-a within a resource group 505-a that is used to calculate LLR scaling for the PDSCH data in that resource group 505-a. Each resource group 505-a may span any quantity of time domain symbol durations. Resource group 505-a1 spans about three time domain symbol durations, as an example.

Reference signals 510-a may be clustered (e.g., grouped, allocated) together within a resource group 505-a. For example, reference signals 510-a1 through 510-a4 are next to each other in the time domain. Clustering one or more subsets of reference signals 510-a together within the resource groups 505-a may reduce latency as the reference signals may begin to be processed (e.g., used to calculate LLR scaling) before the XR device receives of all the symbols (e.g., PDSCH data) associated with that resource group 505-a. For example, the XR device may receive all the reference signals 510-a within a resource group 505-a1 before receiving all the PDSCH data associated with that resource group 505-a1. The XR device may then be able to calculate LLR scaling to apply to the PDSCH before the end time of the resource group 505-a1, thereby reducing latency.

In FIG. 5B, the resource grid 500-b may be an example of a resource grid used for communication via OFDM waveforms. The resource grid 500-b may account for known narrow band interference patterns. The resource grid 500-b may be split into resource groups 505-b. Each resource group may correspond to a portion of the resource grid 500-b that contains PDSCH data, reference signals 510-b, or both. There may be any quantity of resource groups 505-b within the resource grid 500-b, although eight resource groups 505-b (resource groups 505-b1, 505-b2, 505-b3, 505-b4, 505-b5, 505-b6, 505-b7, and 505-b8) are shown. Additionally, there may be any quantity of reference signals 510-b within a resource group 505-b, although six reference signals 510-b (reference signals 510-b1, 510-b2, 510-b3, 510-b4, 510-b5, and 510-b6) are shown, for example, in resource group 505-b1. Each resource group 505-b may contain a repetition or concatenation of reference signals 510-b. An LLR scaling group may refer to the set of reference signals 510-b within a resource group 505-b that is used to calculate LLR scaling for the PDSCH data in that resource group 505-b. Each resource group 505-b may span any quantity of time domain symbol durations (e.g., OFDM symbol durations). Resource group 505-b1 spans four time domain symbol durations, as an example. Resource group 505-b7 spans two time domain symbol durations, as another example. Each resource group 505-b may span any portion of the frequency domain. As an example, each resource group 505-b spans approximately half of the bandwidth shown.

Reference signals 510-b may be clustered (e.g., grouped, allocated) together within a resource group 505-b. For example, reference signals 510-b1, 510-b2, and 510-b3 are next to each other in the frequency domain. Reference signals 510-b4, 510-b5, and 510-b6 are next to each other in the frequency domain, separate from, but within the same reference group as, reference signals 510-b1 through 510-b3. One or more subsets of reference signals 510-b may be clustered together on frequency bands that allow improved mitigation of interference via the LLR scaling based on known narrow band interference patterns. Clustering reference signals 510-b together in resource groups 505-b may reduce latency as the reference signals may begin to be processed (e.g., used to calculate LLR scaling) before the XR device receives of all the symbols (e.g., PDSCH data) associated with that resource group 505-b. For example, the XR device may receive all the reference signals 510-b within the resource group 505-b1 before receiving all the PDSCH data associated with that resource group 505-b1. The XR device may then be able to calculate LLR scaling to apply to the PDSCH before the end time of the resource group 505-b1, thereby reducing latency.

The resource grids 500 may assist the XR device in offloading some processing to the companion UE. By reducing the amount of processing that the XR device performs, the overall processing and performance for the XR device may be improved while allowing a lightweight battery, longer battery lifetime, reduced heat generation, portability and satisfying other limitations.

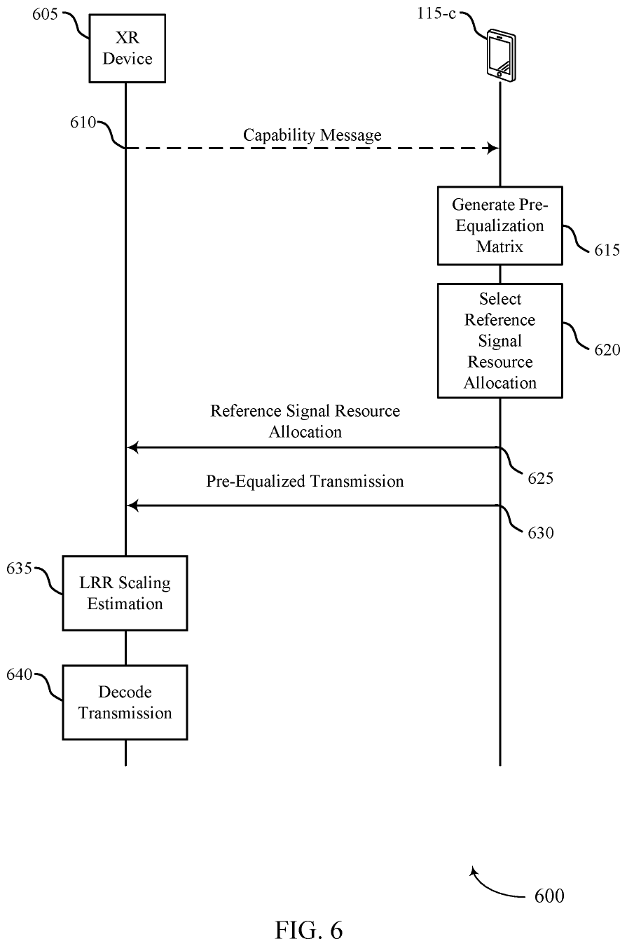

FIG. 6 shows an example of a process flow 600 that supports reference signals for LLR scaling estimation for pre-equalized transmissions in accordance with one or more aspects of the present disclosure. The process flow 600 may implement or may be implemented by aspects of the wireless communications system 100 or the wireless communications system 200. For example, the process flow 600 may include a UE 115 (e.g., a UE 115-c and an XR device 605), which may be examples of the corresponding devices as described with reference to FIG. 1.

In the following description of the process flow 600, the operations between the UE 115-c and the XR device 605 may be transmitted in a different order than the example order shown. Some operations may also be omitted from the process flow 600, and other operations may be added to the process flow 600. Further, although some operations or signaling may be shown to occur at different times for discussion purposes, these operations may actually occur at the same time.

In some examples, at 610, the XR device 605 may transmit, to the UE 115-c, one or more capability messages. The one or more capability messages may indicate a capability of the XR device 605 to perform LLR scaling estimation based on received reference signals.

At 615, the UE 115-c may generate a pre-equalization matrix. In some examples, the UE 115-c may generate the pre-equalization matrix using a trace (e.g., diagonal elements) of a matrix associated with the Rnn. In some examples, the UE 115-c may generate the pre-equalization matrix using all elements of the matrix associated with the Rnn. The UE 115-c may equalize the one or more transmissions using the pre-equalization matrix.

At 620, the UE 115-c may select a resource allocation in a resource grid for transmitting a set of reference signals (e.g., a set of pre-equalized reference signals, a set of LLR scaling reference signals). In some examples, the set of pre-equalized reference signals may be dedicated for estimating LRR scaling coefficients. The UE 115-c may select the resource allocation based on the capability of the XR device 605 to perform LLR scaling estimation and on one or more channel characteristics (e.g., a SNR, a signal-to-noise-plus-interference ratio (SNIR), an amount of interference, a channel quality, or the like). The UE 115-c may select the resource allocation from a plurality of configured (e.g., pre-configured) resource allocations which the UE 115-c may use for transmitting the set of pre-equalized reference signals. The reference signals may be organized within the resource grid associated with communication between the UE 115-c and the XR device 605 depending on the waveform type. For example, the reference signals may be spaced out, with gaps between them (as in resource grids 300 and 400) or the reference signals may be clustered together (as in resource grids 500-a and 500-b).

At 625, the UE 115-c may transmit, to the XR device 605, an indication of a configuration for the selected resource allocation. In other words, the XR device 605 may receive, from the UE 115-c, a message indicating a configuration of a set of LLR scaling reference signals. The configuration may comprise a resource allocation for the set of LLR scaling reference signals that are based on the type of waveform (OFDM, DFT-s-OFDM, among other examples) associated with communication between the UE 115-c and the XR device 605 (e.g., the type of waveform used for the capability message, the indication of the configuration, or the like).

The LLR scaling estimation may be more efficient depending on how the reference signals are organized within the resource grid. The reference signals may be more efficiently organized if the UE 115-c has some side information regarding channel Doppler (e.g., may determine receiving side EVM differences across time domain symbols), interference characteristics (e.g., may follow a known interference pattern), and channel flatness or PRG size (e.g., may determine how post processing the receiving EVM may vary across different resource elements).

The side information may be obtained on the UE 115-c side and then signaled to the XR device 605. The UE 115-c may run Doppler estimations based on uplink reference signals. The UE 115-c may run various estimations for the link between the UE 115-c and the XR device to limit the amount of processing the XR device 605 performs. The UE 115-c may run some interference monitoring or measurement procedures on the UWB band. For example, the UE 115-c may run interference activity measurements which may be representative in general for both the UE 115-c and the XR device 605 receiving sides due to an assumption of a short-range link between the UE 115-c and the XR device 605. The UE 115-c may obtain some collaborative interference measurements or statistics obtained by other UWB devices. For example, other UEs serving as companions to the XR devices 605 and may share UWB interference measurements between them directly or may exchange UWB interference measurements via a network entity (e.g., gNB) that the UEs 115 and the XR devices 205 are connected to. Additionally, or alternatively, an access point (AP) serving a quantity of local XR devices 605 may distribute interference related side information or statistics evaluated by one or more XR devices 605. The side information may allow the UE 115-c to control LLR scaling averaging bounds (e.g., reference signal grouping) for local XR device 605 processing. The UE 115-c may signal related control information to the XR device 605 from time to time.

At 630, the UE 115-c may transmit, to the XR device 605, one or more pre-equalized transmission. In other words, the XR device 205 may receive, from the UE 115-c, one or more pre-equalized transmissions. A pre-equalized transmission may include one or more sets of pre-equalized reference signals (e.g., LLR scaling reference signals) and PDSCH data. For example, the UE 115-c may transmit the pre-equalized reference signals via the selected resource allocation. The UE 115-c may pre-equalize the reference signals, the PDSCH data, or both using the generated pre-equalization matrix. The one or more pre-equalized data transmissions may have the same waveform type as the capability message, indication of the configuration, or the like.

At 635, the XR device 605 may perform LLR scaling estimation. For example, (e.g., if the XR device 605 has the capability to perform LLR scaling estimation), the XR device 605 may generate one or more LLR scaling values (e.g., coefficients) based at least in part on receiving the one or more sets of pre-equalized reference signals (e.g., LLR scaling pilot reference signals) in the pre-equalized transmission. The XR device 605 may apply some form of LLR scaling averaging on top of the reference signals and LLR scaling groups according to some pre-defined grouping of the reference signals.

The XR device 605 may perform different LLR scaling on the received reference signals based on the type of waveform of the pre-equalized transmission. For example, for processing a DFT-S-OFDM transmission, the XR device 605 may use Equation 2:

$${σ}_{TD symbol}^{2} ( i ) = \frac{1}{N} {\sum }_{n = 0}^{N - 1} {\vert - {p}_{n} \vert}^{2} \qquad ( 2 )$$

where i represents a time domain symbol index, N represents a quantity of pilots in the averaging group that contains the i^{th} symbol index within its boundaries, [symbol] represents received pre-equalized pilot symbols belonging to the averaging group that contains the i^{th} symbol index within its boundaries, and pₙ represents reference pilot symbols values corresponding to the pre-equalized pilot symbols.

Alternatively, for processing an OFDM waveform, the XR device 605 may use Equation 3:

$${σ}_{Re}^{2} ( i , j ) = \frac{1}{N * M} {\sum }_{m = 0}^{M - 1} {\sum }_{n = 0}^{N - 1} {\vert - {p}_{n , m} \vert}^{2} \qquad ( 3 )$$

where i represents an OFDM symbol index within the LLR scaling averaging group (e.g., resource group) boundaries, j represents a resource element index within the LLR averaging group boundaries, N represents a quantity of reference signal allocations on the time domain axis (e.g., OFDM symbols) with allocated reference signals in the averaging group that contains the i^{th} OFDM symbol index, M represents a quantity of reference signal allocations on the frequency domain axis (e.g., resource elements) in the averaging group that contains the j^{th} resource element index within the associated resource group, [symbol] represents received pre-equalized reference signal symbols belonging to the averaging group with intra-group indices n, m, and P_{n,m} represents reference signal symbol values corresponding to [symbol] .

Alternatively, for processing an OFDM waveform under some constraints for transmission power or power spectral density (PSD) for UWB, the XR device 605 may use a different scaling process. For example, a constraint for transmitting power or PSD for UWB may limit a threshold power (e.g., maximum power per 1 MHz). To comply with the constraint of a maximum power per 1 MHz transmitted scaling, the XR device 605 may implement a maximum power per 1 MHz receiving de-scaling. When a constraint is applied (e.g., maximum power per 1 MHz on the transmitting side), processing OFDM waveforms may be adjusted to introduce weighted averaging according to an SNR on each reference signal. For example, the OFDM waveform may be processed via Equation 4:

$${σ}_{RE}^{2} ( i , j ) = S {F ( i , j )}^{2} * \frac{1}{N * M} {\sum }_{m = 0}^{M - 1} {\sum }_{n = 0}^{N - 1} \frac{{\vert - {p}_{n , m} \vert}^{2}}{S {F ( m , n )}^{2}} \qquad ( 4 )$$

where i represents an OFDM symbol index within the LLR scaling averaging group boundaries (e.g., resource group), j represents a resource element index within the LLR averaging group boundaries, N represents a quantity of reference signal allocations on the time domain axis (e.g., OFDM symbols) with allocated reference signals in the averaging group that contains the i^{th} OFDM symbol index, M represents a quantity of reference signal allocations on the frequency domain axis (e.g., resource elements) in the averaging group that contains the j^{th} resource element index within the associated resource group, SF (i, j) represents a receiving de-scaling factor for the i^{th} OFDM symbol index within the averaging group boundary, [symbol] represents received pre-equalized reference signal symbols belonging to the averaging group with intra-group indices n, m, and pₙ,m represents reference signal symbol values corresponding to [symbol] .

At 640, the XR device 605 may decode the one or more pre-equalized transmissions from the UE 115-c based on the one or more LLR scaling values. For example, the XR device 605 may decode the one or more transmissions using the one or more LLR scaling values received from the UE 115-c and based on the reference signals.

By performing the method described by the process flow 600, the XR device 605 may be able to offload processing associated with noise reduction to the companion UE 115-c. The XR device 605 may have reduced power consumption (e.g., at the modem) due to shifting channel estimation and equalization related complexity and functionality from the XR device 605 to the companion UE 115-c. This may also simplify the modem hardware of the XR device 605. The method described by the process flow 600 may increase robustness from interference and channel aging effects for pre-equalized transmission schemes over UWB for the XR device 605 sidelink (e.g., due to local LLR scaling estimations on the side of the XR device 605). Downlink overhead and extra control signaling related to LLR scaling signaling from the UE 115-c (transmitting side) may also be avoided by due to pre-equalized transmissions relying on an OFDM waveform (low complexity LLR scaling estimation may be used instead).

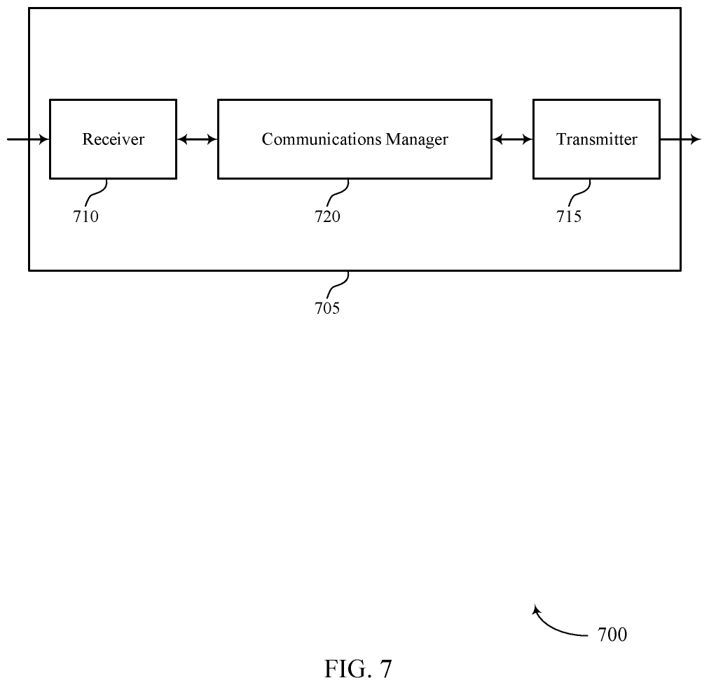

FIG. 7 shows a block diagram 700 of a device 705 that supports reference signals for LLR scaling estimation for pre-equalized transmissions in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to reference signals for LLR scaling estimation for pre-equalized transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reference signals for LLR scaling estimation for pre-equalized transmissions). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of reference signals for LLR scaling estimation for pre-equalized transmissions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving, from a UE, a message indicating a configuration of a set of LLR scaling reference signals, the configuration including a resource allocation for the set of LLR scaling reference signals that is based on a waveform type associated with communications between the UE and the wireless device. The communications manager 720 is capable of, configured to, or operable to support a means for receiving, from the UE, one or more pre-equalized data transmissions that include the set of LLR scaling reference signals in accordance with the resource allocation, the one or more pre-equalized data transmissions having the waveform type. The communications manager 720 is capable of, configured to, or operable to support a means for decoding the one or more pre-equalized data transmissions based on LLR scaling using the set of LLR scaling reference signals.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for offloading processing associated with noise reduction from an XR device to an associated UE (or another device). The described techniques may enable reduced power consumption at the XR device (e.g., at least at the modem of the XR device) due to shifting channel estimation and equalization related complexity and functionality from the XR device to the associated UE. Such techniques may also enable simplified modem hardware of the XR device. Further, one or more groups of reference signals dedicated to LLR scaling may enable efficient measurement and LLR scaling and estimation procedures at the XR device, resulting in efficient decoding of pre-equalized signals that are received from another, companion device (e.g., a UE or the like).

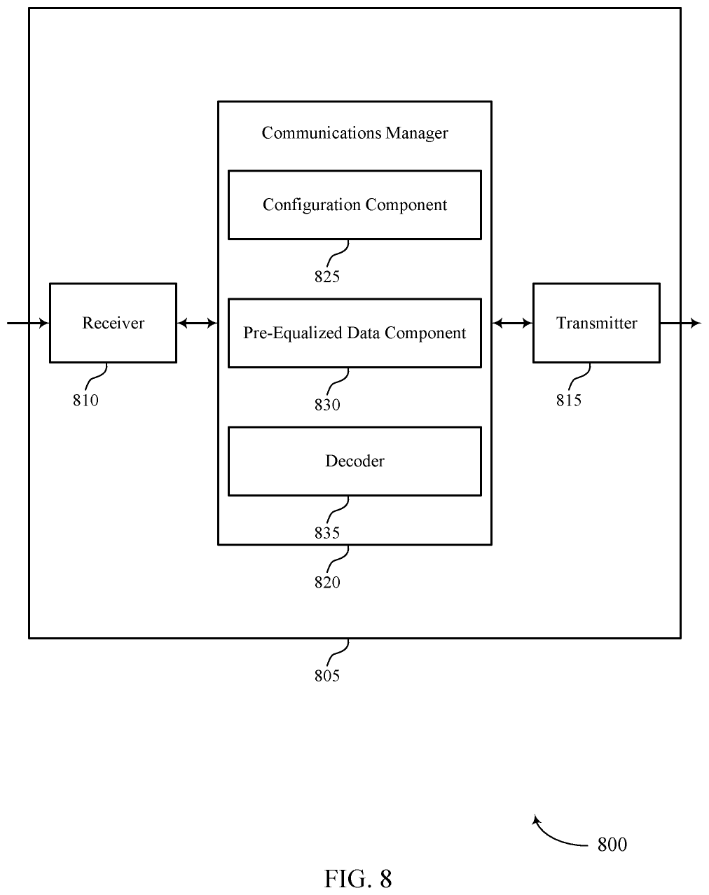

FIG. 8 shows a block diagram 800 of a device 805 that supports reference signals for LLR scaling estimation for pre-equalized transmissions in accordance with one or more aspects of the present disclosure. The device 805 may be an example of aspects of a device 705 or a wireless device 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to reference signals for LLR scaling estimation for pre-equalized transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reference signals for LLR scaling estimation for pre-equalized transmissions). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of reference signals for LLR scaling estimation for pre-equalized transmissions as described herein. For example, the communications manager 820 may include a configuration component 825, a pre-equalized data component 830, a decoder 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The configuration component 825 is capable of, configured to, or operable to support a means for receiving, from a UE, a message indicating a configuration of a set of LLR scaling reference signals, the configuration including a resource allocation for the set of LLR scaling reference signals that is based on a waveform type associated with communications between the UE and the wireless device. The pre-equalized data component 830 is capable of, configured to, or operable to support a means for receiving, from the UE, one or more pre-equalized data transmissions that include the set of LLR scaling reference signals in accordance with the resource allocation, the one or more pre-equalized data transmissions having the waveform type. The decoder 835 is capable of, configured to, or operable to support a means for decoding the one or more pre-equalized data transmissions based on LLR scaling using the set of LLR scaling reference signals.

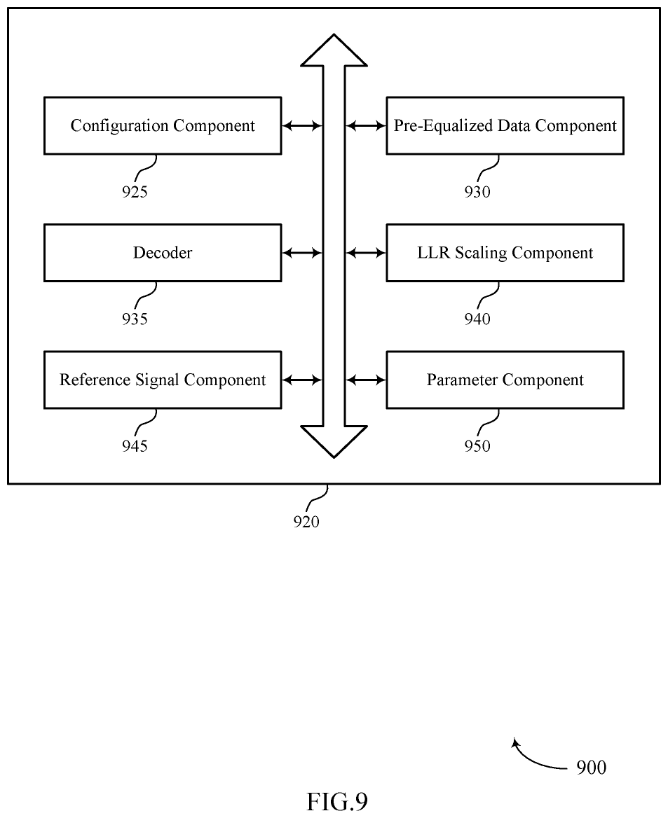

FIG. 9 shows a block diagram 900 of a communications manager 920 that supports reference signals for LLR scaling estimation for pre-equalized transmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of reference signals for LLR scaling estimation for pre-equalized transmissions as described herein. For example, the communications manager 920 may include a configuration component 925, a pre-equalized data component 930, a decoder 935, an LLR scaling component 940, a reference signal component 945, a parameter component 950, or any combination thereof. Each of these components, or components or subcomponents thereof (e.g., one or more processors, one or more memories), may communicate, directly or indirectly, with one another (e.g., via one or more buses).

The configuration component 925 is capable of, configured to, or operable to support a means for receiving, from a UE, a message indicating a configuration of a set of LLR scaling reference signals, the configuration including a resource allocation for the set of LLR scaling reference signals that is based on a waveform type associated with communications between the UE and the wireless device. The pre-equalized data component 930 is capable of, configured to, or operable to support a means for receiving, from the UE, one or more pre-equalized data transmissions that include the set of LLR scaling reference signals in accordance with the resource allocation, the one or more pre-equalized data transmissions having the waveform type. The decoder 935 is capable of, configured to, or operable to support a means for decoding the one or more pre-equalized data transmissions based on LLR scaling using the set of LLR scaling reference signals.

In some examples, the LLR scaling component 940 is capable of, configured to, or operable to support a means for performing the LLR scaling for the one or more pre-equalized data transmissions, where the LLR scaling is different for each resource element per symbol period of the one or more pre-equalized data transmissions, the waveform type of the one or more pre-equalized data transmissions including an OFDM waveform. In some examples, the resource allocation for the set of LLR scaling reference signals includes a two-dimensional grid including respective resources in a time domain and a frequency domain based on the OFDM waveform.

In some examples, the reference signal component 945 is capable of, configured to, or operable to support a means for receiving, based on the configuration, the set of LLR scaling reference signals in accordance with the two-dimensional grid, where a density of the set of LLR scaling reference signals in the two-dimensional grid is based on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

In some examples, the LLR scaling component 940 is capable of, configured to, or operable to support a means for performing the LLR scaling for the one or more pre-equalized data transmissions, where the LLR scaling is different for each symbol period of the one or more pre-equalized data transmissions, the waveform type of the one or more pre-equalized data transmissions including a DFT-s-OFDM waveform. In some examples, the resource allocation for the set of LLR scaling reference signals includes a one-dimensional grid including respective resources in a time domain based on the DFT-s-OFDM waveform.

In some examples, the reference signal component 945 is capable of, configured to, or operable to support a means for receiving, based on the configuration, the set of LLR scaling reference signals in accordance with the one-dimensional grid, where a density of the set of LLR scaling reference signals in the time domain is based on a range of signal-to-noise ratios, a range of modulation and coding schemes, one or more mobility parameters, one or more interference characteristics in the time domain, one or more parameters associated with nonstationary interference, or any combination thereof.

In some examples, the set of LLR scaling reference signals include one or more subsets of LLR scaling reference signals included in respective groups in accordance with the configuration. In some examples, the LLR scaling is based on the respective groups.

In some examples, the reference signal component 945 is capable of, configured to, or operable to support a means for receiving, based on the configuration, the set of LLR scaling reference signals, where the set of LLR scaling reference signals include one or more blocks of LLR scaling reference signals, each block including a repetition or concatenation of a respective LLR scaling reference signal, and each block being separated by a time-domain gap or a frequency-domain gap based on the waveform type.

In some examples, the parameter component 950 is capable of, configured to, or operable to support a means for receiving, from the UE, one or more messages indicating one or more parameters associated with communicating with the UE, where the configuration of the set of LLR scaling reference signals is based on the one or more parameters.

In some examples, the one or more parameters are associated with channel Doppler effects, interference characteristics, a channel flatness, a physical resource group size, or any combination thereof. In some examples, the configuration is indicated for each component carrier of a set of component carriers associated with communication between the wireless device and the UE.

In some examples, to support receiving the message indicating the configuration, the configuration component 925 is capable of, configured to, or operable to support a means for receiving an RRC message, a MAC-CE, DCI, or any combination thereof, indicating the configuration of the set of LLR scaling reference signals.

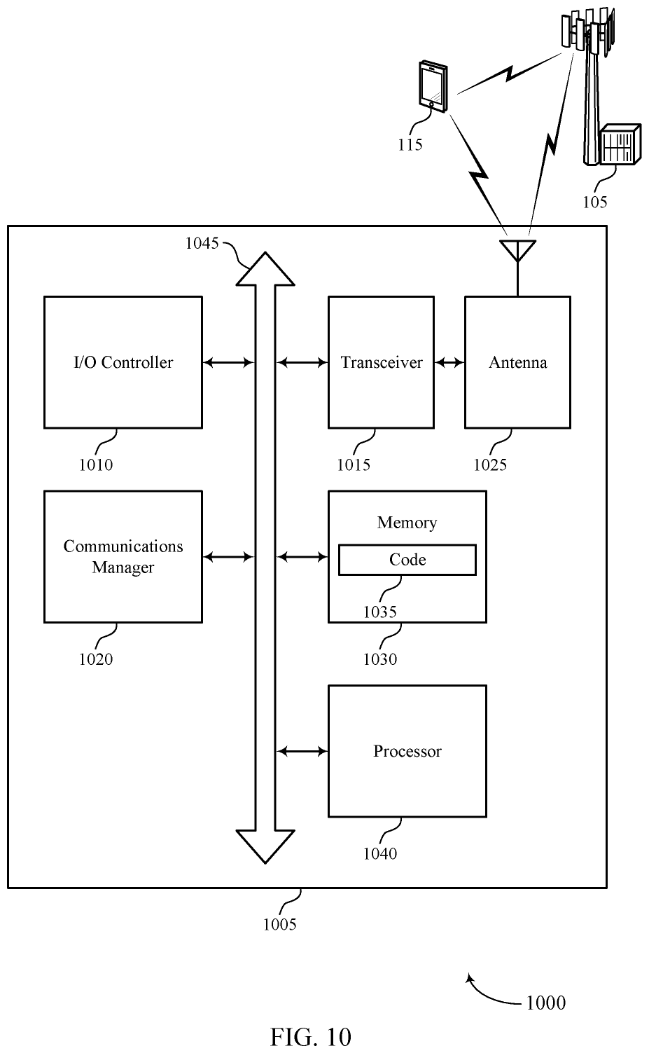

FIG. 10 shows a diagram of a system 1000 including a device 1005 that supports reference signals for LLR scaling estimation for pre-equalized transmissions in accordance with one or more aspects of the present disclosure. The device 1005 may be an example of or include the components of a device 705, a device 805, or a wireless device as described herein. The device 1005 may include components for bi-directional voice and data communications including components for transmitting and receiving communications, such as a communications manager 1020, an I/O controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOSR, ANDROIDR, MS-DOSR, MS-WINDOWS®, OS/2R, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random-access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS), which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting reference signals for LLR scaling estimation for pre-equalized transmissions). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

For example, the communications manager 1020 is capable of, configured to, or operable to support a means for receiving, from a UE, a message indicating a configuration of a set of LLR scaling reference signals, the configuration including a resource allocation for the set of LLR scaling reference signals that is based on a waveform type associated with communications between the UE and the wireless device. The communications manager 1020 is capable of, configured to, or operable to support a means for receiving, from the UE, one or more pre-equalized data transmissions that include the set of LLR scaling reference signals in accordance with the resource allocation, the one or more pre-equalized data transmissions having the waveform type. The communications manager 1020 is capable of, configured to, or operable to support a means for decoding the one or more pre-equalized data transmissions based on LLR scaling using the set of LLR scaling reference signals.

By including or configuring the communications manager 1020 in accordance with examples as described herein, the device 1005 may support techniques for improved user experience related to reduced processing, reduced power consumption, more efficient utilization of communication resources, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of reference signals for LLR scaling estimation for pre-equalized transmissions as described herein, or the at least one processor 1040 and the at least one memory 1030 may be otherwise configured to, individually or collectively, perform or support such operations.

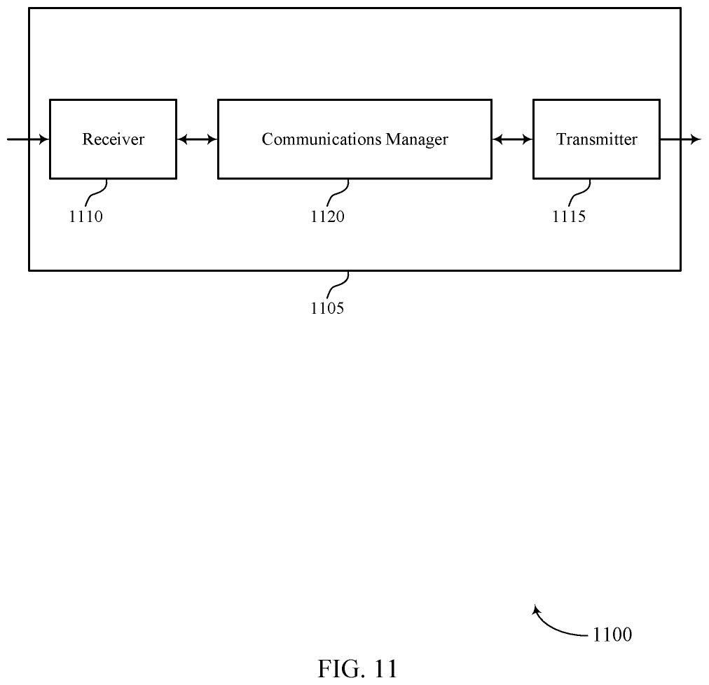

FIG. 11 shows a block diagram 1100 of a device 1105 that supports reference signals for LLR scaling estimation for pre-equalized transmissions in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to reference signals for LLR scaling estimation for pre-equalized transmissions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to reference signals for LLR scaling estimation for pre-equalized transmissions). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of reference signals for LLR scaling estimation for pre-equalized transmissions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

For example, the communications manager 1120 is capable of, configured to, or operable to support a means for transmitting, to a wireless device, a message indicating a configuration of a set of LLR scaling reference signals, the configuration including a resource allocation for the set of LLR scaling reference signals that is based on a waveform type (e.g., an OFDM waveform, an SC waveform, a DFT-s-OFDM waveform) associated with communications between the wireless device and the UE. The communications manager 1120 is capable of, configured to, or operable to support a means for transmitting, to the wireless device, one or more pre-equalized data transmissions that include the set of LLR scaling reference signals in accordance with the resource allocation, the one or more pre-equalized data transmissions having the waveform type.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for offloading processing associated with noise reduction from an XR device to an associated UE. The described techniques may support the transfer of channel estimation and equalization-related complexity and functionalities from the XR device to the UE. Such techniques may support simplified modem hardware of the XR device. Further, one or more groups of reference signals dedicated to LLR scaling and transmitted by the UE may enable efficient measurements and LLR scaling and estimation procedures at the XR device, resulting in efficient decoding of pre-equalized signals that are transmitted by the UE.

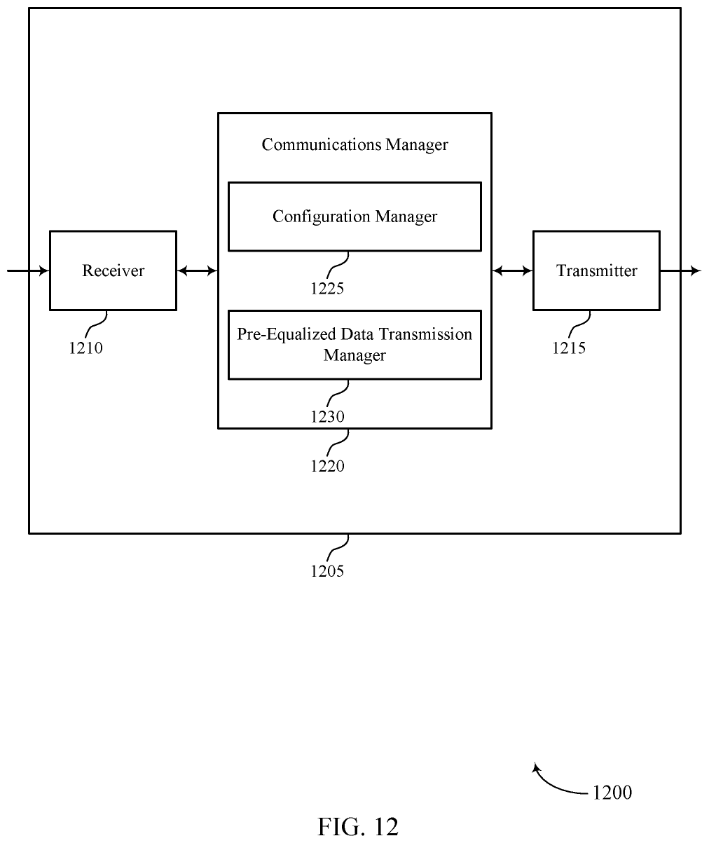

FIG. 12 shows a block diagram 1200 of a device 1205 that supports reference signals for LLR scaling estimation for pre-equalized transmissions in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to reference signals for LLR scaling estimation for pre-equalized transmissions). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to reference signals for LLR scaling estimation for pre-equalized transmissions). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of reference signals for LLR scaling estimation for pre-equalized transmissions as described herein. For example, the communications manager 1220 may include a configuration manager 1225 a pre-equalized data transmission manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The configuration manager 1225 is capable of, configured to, or operable to support a means for transmitting, to a wireless device, a message indicating a configuration of a set of LLR scaling reference signals, the configuration including a resource allocation for the set of LLR scaling reference signals that is based on a waveform type associated with communications between the wireless device and the UE. The pre-equalized data transmission manager 1230 is capable of, configured to, or operable to support a means for transmitting, to the wireless device, one or more pre-equalized data transmissions that include the set of LLR scaling reference signals in accordance with the resource allocation, the one or more pre-equalized data transmissions having the waveform type.

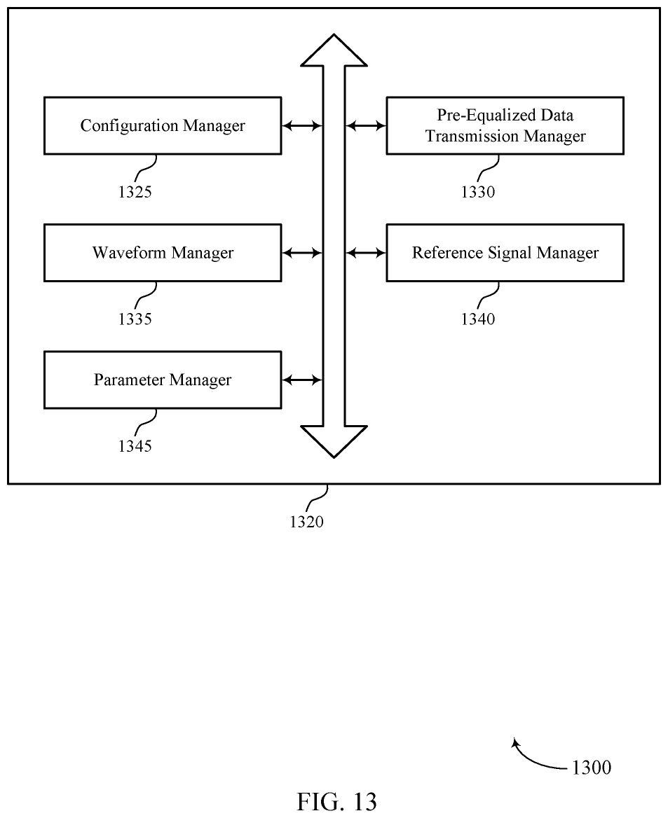

FIG. 13 shows a block diagram 1300 of a communications manager 1320 that supports reference signals for LLR scaling estimation for pre-equalized transmissions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of reference signals for LLR scaling estimation for pre-equalized transmissions as described herein. For example, the communications manager 1320 may include a configuration manager 1325, a pre-equalized data transmission manager 1330, a waveform manager 1335, a reference signal manager 1340, a parameter manager 1345, or any combination thereof. Each of these components, or components or subcomponents thereof (e.g., one or more processors, one or more memories), may communicate, directly or indirectly, with one another (e.g., via one or more buses).

The configuration manager 1325 is capable of, configured to, or operable to support a means for transmitting, to a wireless device, a message indicating a configuration of a set of LLR scaling reference signals, the configuration including a resource allocation for the set of LLR scaling reference signals that is based on a waveform type associated with communications between the wireless device and the UE. The pre-equalized data transmission manager 1330 is capable of, configured to, or operable to support a means for transmitting, to the wireless device, one or more pre-equalized data transmissions that include the set of LLR scaling reference signals in accordance with the resource allocation, the one or more pre-equalized data transmissions having the waveform type.

In some examples, the waveform manager 1335 is capable of, configured to, or operable to support a means for determining that the waveform type includes an OFDM waveform, where the resource allocation for the set of LLR scaling reference signals includes a two-dimensional grid including respective resources in a time domain and a frequency domain based on the OFDM waveform.

In some examples, the reference signal manager 1340 is capable of, configured to, or operable to support a means for transmitting, based on the configuration, the set of LLR scaling reference signals in accordance with the two-dimensional grid, where a density of the set of LLR scaling reference signals in the two-dimensional grid is based on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

In some examples, the waveform manager 1335 is capable of, configured to, or operable to support a means for determining that the waveform type includes a DFT-s-OFDM waveform, where the resource allocation for the set of LLR scaling reference signals includes a one-dimensional grid including respective resources in a time domain based on the DFT-s-OFDM waveform.

In some examples, the reference signal manager 1340 is capable of, configured to, or operable to support a means for receiving, based on the configuration, the set of LLR scaling reference signals in accordance with the one-dimensional grid, where a density of the set of LLR scaling reference signals in the time domain is based on a range of signal-to-noise ratios, a range of modulation and coding schemes, one or more mobility parameters, one or more interference characteristics in the time domain, one or more parameters associated with nonstationary interference, or any combination thereof.

In some examples, the reference signal manager 1340 is capable of, configured to, or operable to support a means for transmitting, based on the configuration, the set of LLR scaling reference signals, where the set of LLR scaling reference signals include one or more blocks of LLR scaling reference signals, each block including a repetition or concatenation of a respective LLR scaling reference signal, and each block being separated by a time-domain gap or a frequency-domain gap based on the waveform type.

In some examples, the parameter manager 1345 is capable of, configured to, or operable to support a means for determining one or more parameters associated with communicating with the wireless device, where the configuration of the set of LLR scaling reference signals is based on the one or more parameters. In some examples, the parameter manager 1345 is capable of, configured to, or operable to support a means for transmitting, to the wireless device, one or more messages indicating the one or more parameters.

In some examples, the one or more parameters are associated with channel Doppler effects, interference characteristics, a channel flatness, a physical resource group size, or any combination thereof. In some examples, the configuration is indicated for each component carrier of a set of component carriers associated with communication between the wireless device and the UE.

In some examples, to support transmitting the message indicating the configuration, the configuration manager 1325 is capable of, configured to, or operable to support a means for transmitting an RRC message, a MAC-CE, DCI, or any combination thereof, indicating the configuration of the set of LLR scaling reference signals.

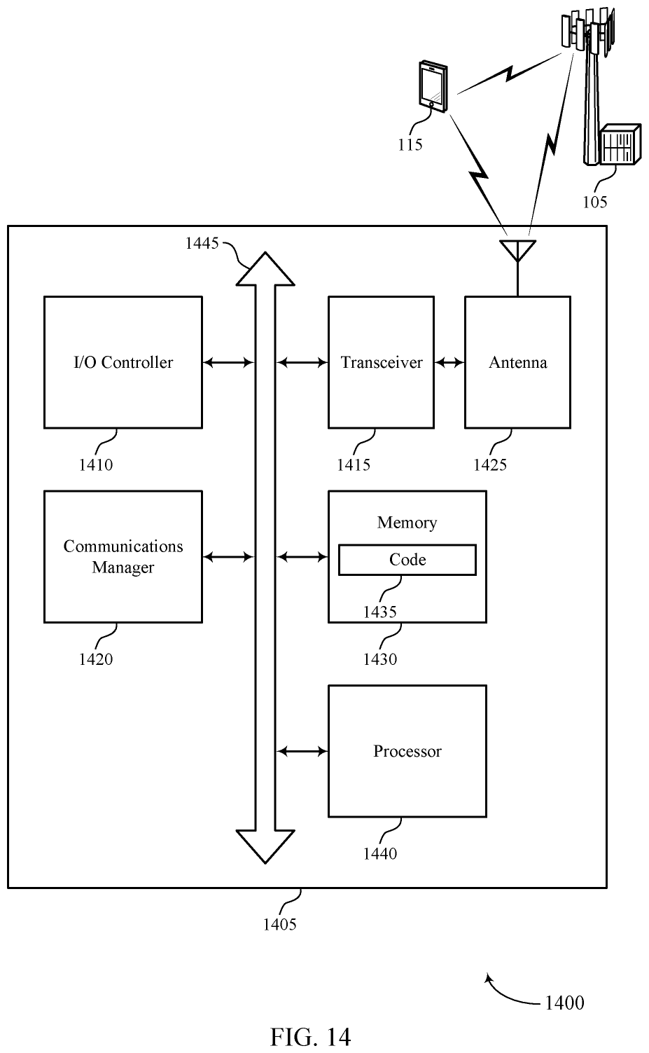

FIG. 14 shows a diagram of a system 1400 including a device 1405 that supports reference signals for LLR scaling estimation for pre-equalized transmissions in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an I/O controller 1410, a transceiver 1415, an antenna 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOSR, ANDROIDR, MS-DOSR, MS-WINDOWS®, OS/2R, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include RAM and ROM. The at least one memory 1430 may store computer-readable, computer-executable code 1435 including instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may contain, among other things, a BIOS which may control basic hardware or software operation such as the interaction with peripheral components or devices.

The at least one processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting reference signals for LLR scaling estimation for pre-equalized transmissions). For example, the device 1405 or a component of the device 1405 may include at least one processor 1440 and at least one memory 1430 coupled with or to the at least one processor 1440, the at least one processor 1440 and at least one memory 1430 configured to perform various functions described herein. In some examples, the at least one processor 1440 may include multiple processors and the at least one memory 1430 may include multiple memories. One or more of the multiple processors may be coupled with one or more of the multiple memories, which may, individually or collectively, be configured to perform various functions herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1430 or otherwise, to perform one or more of the functions described herein.

For example, the communications manager 1420 is capable of, configured to, or operable to support a means for transmitting, to a wireless device, a message indicating a configuration of a set of LLR scaling reference signals, the configuration including a resource allocation for the set of LLR scaling reference signals that is based on a waveform type associated with communications between the wireless device and the UE. The communications manager 1420 is capable of, configured to, or operable to support a means for transmitting, to the wireless device, one or more pre-equalized data transmissions that include the set of LLR scaling reference signals in accordance with the resource allocation, the one or more pre-equalized data transmissions having the waveform type.

By including or configuring the communications manager 1420 in accordance with examples as described herein, the device 1405 may support techniques for improved user experience related to reduced processing, reduced power consumption, more efficient utilization of communication resources, longer battery life, and improved utilization of processing capability.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of reference signals for LLR scaling estimation for pre-equalized transmissions as described herein, or the at least one processor 1440 and the at least one memory 1430 may be otherwise configured to, individually or collectively, perform or support such operations.

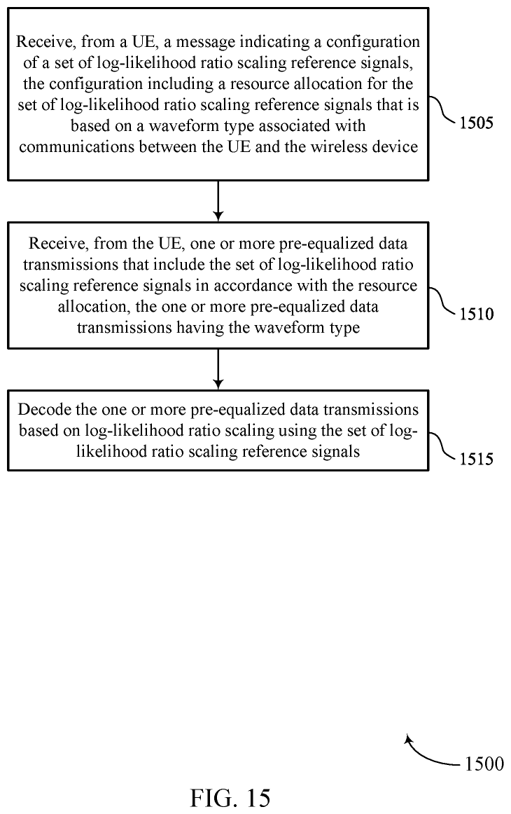

FIG. 15 shows a flowchart illustrating a method 1500 that supports reference signals for LLR scaling estimation for pre-equalized transmissions in accordance with one or more aspects of the present disclosure. The operations of the method 1500 may be implemented by a wireless device or its components as described herein. For example, the operations of the method 1500 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1505, the method may include receiving, from a UE, a message indicating a configuration of a set of LLR scaling reference signals, the configuration including a resource allocation for the set of LLR scaling reference signals that is based on a waveform type associated with communications between the UE and the wireless device. The operations of 1505 may be performed in accordance with examples as disclosed herein. In some examples, aspects of the operations of 1505 may be performed by a configuration component 925 as described with reference to FIG. 9.

At 1510, the method may include receiving, from the UE, one or more pre-equalized data transmissions that include the set of LLR scaling reference signals in accordance with the resource allocation, the one or more pre-equalized data transmissions having the waveform type. The operations of 1510 may be performed in accordance with examples as disclosed herein. In some examples, aspects of the operations of 1510 may be performed by a pre-equalized data component 930 as described with reference to FIG. 9.

At 1515, the method may include decoding the one or more pre-equalized data transmissions based on LLR scaling using the set of LLR scaling reference signals. The operations of 1515 may be performed in accordance with examples as disclosed herein. In some examples, aspects of the operations of 1515 may be performed by a decoder 935 as described with reference to FIG. 9.

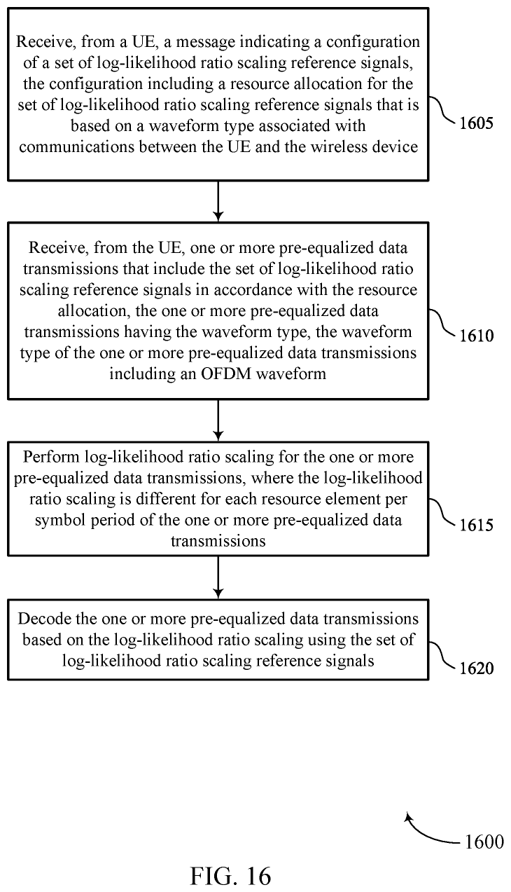

FIG. 16 shows a flowchart illustrating a method 1600 that supports reference signals for LLR scaling estimation for pre-equalized transmissions in accordance with one or more aspects of the present disclosure. The operations of the method 1600 may be implemented by a wireless device or its components as described herein. For example, the operations of the method 1600 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1605, the method may include receiving, from a UE, a message indicating a configuration of a set of LLR scaling reference signals, the configuration including a resource allocation for the set of LLR scaling reference signals that is based on a waveform type associated with communications between the UE and the wireless device. The operations of 1605 may be performed in accordance with examples as disclosed herein. In some examples, aspects of the operations of 1605 may be performed by a configuration component 925 as described with reference to FIG. 9.

At 1610, the method may include receiving, from the UE, one or more pre-equalized data transmissions that include the set of LLR scaling reference signals in accordance with the resource allocation, the one or more pre-equalized data transmissions having the waveform type, the waveform type of the one or more pre-equalized data transmissions including an OFDM waveform. The operations of 1610 may be performed in accordance with examples as disclosed herein. In some examples, aspects of the operations of 1610 may be performed by a pre-equalized data component 930 as described with reference to FIG. 9.

At 1615, the method may include performing LLR scaling for the one or more pre-equalized data transmissions, where the LLR scaling is different for each resource element per symbol period of the one or more pre-equalized data transmissions. The operations of 1615 may be performed in accordance with examples as disclosed herein. In some examples, aspects of the operations of 1615 may be performed by an LLR scaling component 940 as described with reference to FIG. 9.

At 1620, the method may include decoding the one or more pre-equalized data transmissions based on the LLR scaling using the set of LLR scaling reference signals. The operations of 1620 may be performed in accordance with examples as disclosed herein. In some examples, aspects of the operations of 1620 may be performed by a decoder 935 as described with reference to FIG. 9.

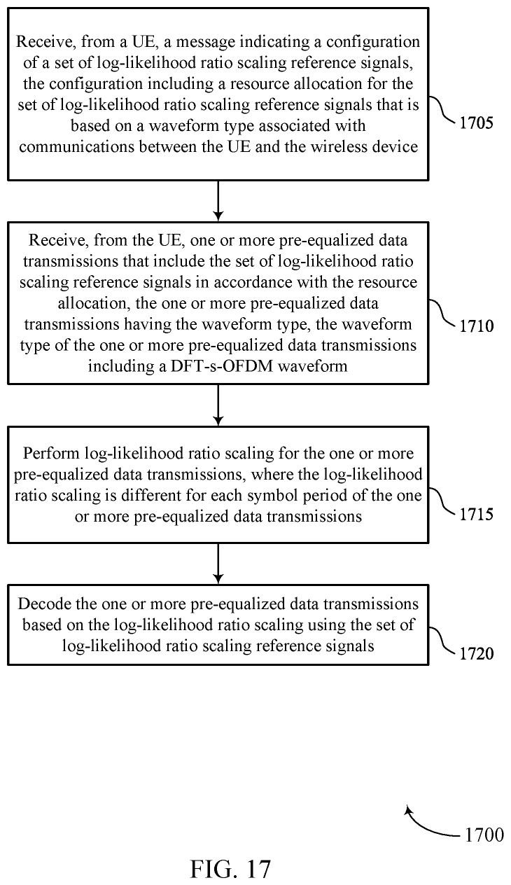

FIG. 17 shows a flowchart illustrating a method 1700 that supports reference signals for LLR scaling estimation for pre-equalized transmissions in accordance with one or more aspects of the present disclosure. The operations of the method 1700 may be implemented by a wireless device or its components as described herein. For example, the operations of the method 1700 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1705, the method may include receiving, from a UE, a message indicating a configuration of a set of LLR scaling reference signals, the configuration including a resource allocation for the set of LLR scaling reference signals that is based on a waveform type associated with communications between the UE and the wireless device. The operations of 1705 may be performed in accordance with examples as disclosed herein. In some examples, aspects of the operations of 1705 may be performed by a configuration component 925 as described with reference to FIG. 9.

At 1710, the method may include receiving, from the UE, one or more pre-equalized data transmissions that include the set of LLR scaling reference signals in accordance with the resource allocation, the one or more pre-equalized data transmissions having the waveform type, the waveform type of the one or more pre-equalized data transmissions including a DFT-s-OFDM waveform. The operations of 1710 may be performed in accordance with examples as disclosed herein. In some examples, aspects of the operations of 1710 may be performed by a pre-equalized data component 930 as described with reference to FIG. 9.

At 1715, the method may include performing LLR scaling for the one or more pre-equalized data transmissions, where the LLR scaling is different for each symbol period of the one or more pre-equalized data transmissions. The operations of 1715 may be performed in accordance with examples as disclosed herein. In some examples, aspects of the operations of 1715 may be performed by an LLR scaling component 940 as described with reference to FIG. 9.

At 1720, the method may include decoding the one or more pre-equalized data transmissions based on LLR scaling using the set of LLR scaling reference signals. The operations of 1720 may be performed in accordance with examples as disclosed herein. In some examples, aspects of the operations of 1720 may be performed by a decoder 935 as described with reference to FIG. 9.

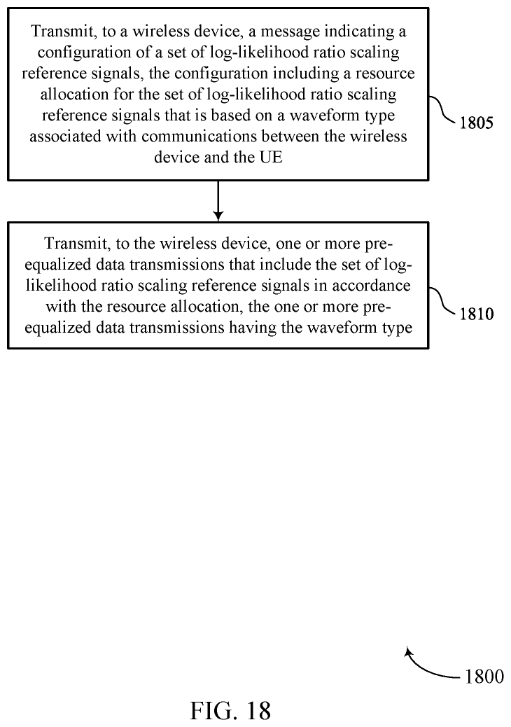

FIG. 18 shows a flowchart illustrating a method 1800 that supports reference signals for LLR scaling estimation for pre-equalized transmissions in accordance with one or more aspects of the present disclosure. The operations of the method 1800 may be implemented by a UE or its components as described herein. For example, the operations of the method 1800 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1805, the method may include transmitting, to a wireless device, a message indicating a configuration of a set of LLR scaling reference signals, the configuration including a resource allocation for the set of LLR scaling reference signals that is based on a waveform type associated with communications between the wireless device and the UE. The operations of 1805 may be performed in accordance with examples as disclosed herein. In some examples, aspects of the operations of 1805 may be performed by a configuration manager 1325 as described with reference to FIG. 13.

At 1810, the method may include transmitting, to the wireless device, one or more pre-equalized data transmissions that include the set of LLR scaling reference signals in accordance with the resource allocation, the one or more pre-equalized data transmissions having the waveform type. The operations of 1810 may be performed in accordance with examples as disclosed herein. In some examples, aspects of the operations of 1810 may be performed by a pre-equalized data transmission manager 1330 as described with reference to FIG. 13.

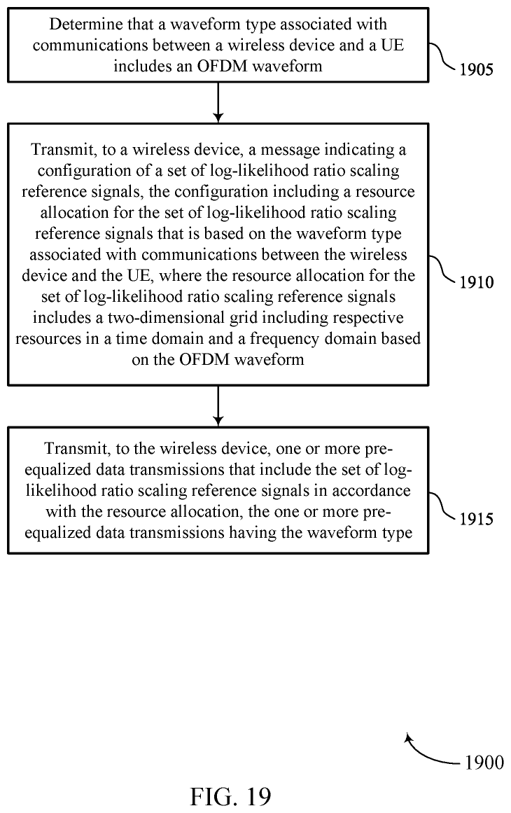

FIG. 19 shows a flowchart illustrating a method 1900 that supports reference signals for LLR scaling estimation for pre-equalized transmissions in accordance with one or more aspects of the present disclosure. The operations of the method 1900 may be implemented by a UE or its components as described herein. For example, the operations of the method 1900 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1905, the method may include determining that a waveform type associated with communications between a wireless device and the UE includes an OFDM waveform. The operations of 1905 may be performed in accordance with examples as disclosed herein. In some examples, aspects of the operations of 1905 may be performed by a waveform manager 1335 as described with reference to FIG. 13.

At 1910, the method may include transmitting, to a wireless device, a message indicating a configuration of a set of LLR scaling reference signals, the configuration including a resource allocation for the set of LLR scaling reference signals that is based on the waveform type associated with communications between the wireless device and the UE, where the resource allocation for the set of LLR scaling reference signals includes a two-dimensional grid including respective resources in a time domain and a frequency domain based on the OFDM waveform. The operations of 1910 may be performed in accordance with examples as disclosed herein. In some examples, aspects of the operations of 1910 may be performed by a configuration manager 1325 as described with reference to FIG. 13.

At 1915, the method may include transmitting, to the wireless device, one or more pre-equalized data transmissions that include the set of LLR scaling reference signals in accordance with the resource allocation, the one or more pre-equalized data transmissions having the waveform type. The operations of 1915 may be performed in accordance with examples as disclosed herein. In some examples, aspects of the operations of 1915 may be performed by a pre-equalized data transmission manager 1330 as described with reference to FIG. 13.

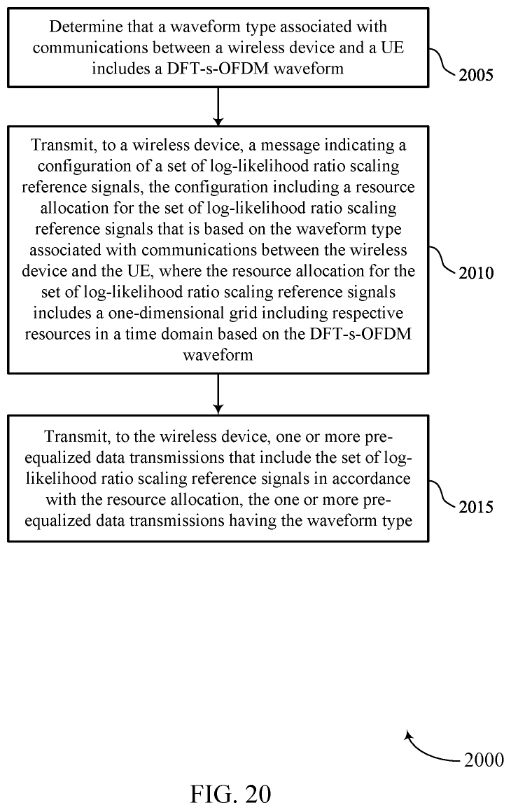

FIG. 20 shows a flowchart illustrating a method 2000 that supports reference signals for LLR scaling estimation for pre-equalized transmissions in accordance with one or more aspects of the present disclosure. The operations of the method 2000 may be implemented by a UE or its components as described herein. For example, the operations of the method 2000 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 2005, the method may include determining that a waveform type associated with communications between a wireless device and the UE includes a DFT-s-OFDM waveform. The operations of 2005 may be performed in accordance with examples as disclosed herein. In some examples, aspects of the operations of 2005 may be performed by a waveform manager 1335 as described with reference to FIG. 13.

At 2010, the method may include transmitting, to a wireless device, a message indicating a configuration of a set of LLR scaling reference signals, the configuration including a resource allocation for the set of LLR scaling reference signals that is based on the waveform type associated with communications between the wireless device and the UE, where the resource allocation for the set of LLR scaling reference signals includes a one-dimensional grid including respective resources in a time domain based on the DFT-s-OFDM waveform. The operations of 2010 may be performed in accordance with examples as disclosed herein. In some examples, aspects of the operations of 2010 may be performed by a configuration manager 1325 as described with reference to FIG. 13.

At 2015, the method may include transmitting, to the wireless device, one or more pre-equalized data transmissions that include the set of LLR scaling reference signals in accordance with the resource allocation, the one or more pre-equalized data transmissions having the waveform type. The operations of 2015 may be performed in accordance with examples as disclosed herein. In some examples, aspects of the operations of 2015 may be performed by a pre-equalized data transmission manager 1330 as described with reference to FIG. 13.

The following provides an overview of aspects of the present disclosure:
Aspect 1: A method for wireless communications by a wireless device, comprising: receiving, from a UE, a message indicating a configuration of a set of LLR scaling reference signals, the configuration comprising a resource allocation for the set of LLR scaling reference signals that is based at least in part on a waveform type associated with communications between the UE and the wireless device: receiving, from the UE, one or more pre-equalized data transmissions that include the set of LLR scaling reference signals in accordance with the resource allocation, the one or more pre-equalized data transmissions having the waveform type; and decoding the one or more pre-equalized data transmissions based at least in part on LLR scaling using the set of LLR scaling reference signals.
Aspect 2: The method of aspect 1, further comprising: performing the LLR scaling for the one or more pre-equalized data transmissions, wherein the LLR scaling is different for each resource element per symbol period of the one or more pre-equalized data transmissions, the waveform type of the one or more pre-equalized data transmissions comprising an orthogonal frequency division multiplexing (OFDM) waveform.
Aspect 3: The method of aspect 2, wherein the resource allocation for the set of LLR scaling reference signals comprises a two-dimensional grid comprising respective resources in a time domain and a frequency domain based at least in part on the OFDM waveform.
Aspect 4: The method of aspect 3, further comprising: receiving, based at least in part on the configuration, the set of LLR scaling reference signals in accordance with the two-dimensional grid, wherein a density of the set of LLR scaling reference signals in the two-dimensional grid is based at least in part on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.
Aspect 5: The method of aspect 1, further comprising: performing the LLR scaling for the one or more pre-equalized data transmissions, wherein the LLR scaling is different for each symbol period of the one or more pre-equalized data transmissions, the waveform type of the one or more pre-equalized data transmissions comprising a discrete Fourier transform-spread-orthogonal frequency division multiplexing (DFT-s-OFDM) waveform.
Aspect 6: The method of aspect 5, wherein the resource allocation for the set of LLR scaling reference signals comprises a one-dimensional grid comprising respective resources in a time domain based at least in part on the DFT-s-OFDM waveform.
Aspect 7: The method of aspect 6, further comprising: receiving, based at least in part on the configuration, the set of LLR scaling reference signals in accordance with the one-dimensional grid, wherein a density of the set of LLR scaling reference signals in the time domain is based at least in part on a range of signal-to-noise ratios, a range of modulation and coding schemes, one or more mobility parameters, one or more interference characteristics in the time domain, one or more parameters associated with nonstationary interference, or any combination thereof.
Aspect 8: The method of any of aspects 1 through 7, wherein the set of LLR scaling reference signals comprise one or more subsets of LLR scaling reference signals included in respective groups in accordance with the configuration, the LLR scaling is based at least in part on the respective groups.
Aspect 9: The method of any of aspects 1 through 8, further comprising: receiving, based at least in part on the configuration, the set of LLR scaling reference signals, wherein the set of LLR scaling reference signals comprise one or more blocks of LLR scaling reference signals, each block comprising a repetition or concatenation of a respective LLR scaling reference signal, and each block being separated by a time-domain gap or a frequency-domain gap based at least in part on the waveform type.
Aspect 10: The method of any of aspects 1 through 9, further comprising: receiving, from the UE, one or more messages indicating one or more parameters associated with communicating with the UE, wherein the configuration of the set of LLR scaling reference signals is based at least in part on the one or more parameters.
Aspect 11: The method of aspect 10, wherein the one or more parameters are associated with channel Doppler effects, interference characteristics, a channel flatness, a physical resource group size, or any combination thereof.
Aspect 12: The method of any of aspects 1 through 11, wherein the configuration is indicated for each component carrier of a set of component carriers associated with communication between the wireless device and the UE.
Aspect 13: The method of any of aspects 1 through 12, wherein receiving the message indicating the configuration comprises: receiving an RRC message, a medium access control-control element (MAC-CE), downlink control information, or any combination thereof, indicating the configuration of the set of LLR scaling reference signals.
Aspect 14: A method for wireless communications by a UE, comprising: transmitting, to a wireless device, a message indicating a configuration of a set of LLR scaling reference signals, the configuration comprising a resource allocation for the set of LLR scaling reference signals that is based at least in part on a waveform type associated with communications between the wireless device and the UE; and transmitting, to the wireless device, one or more pre-equalized data transmissions that include the set of LLR scaling reference signals in accordance with the resource allocation, the one or more pre-equalized data transmissions having the waveform type.
Aspect 15: The method of aspect 14, further comprising: determining that the waveform type comprises an OFDM waveform, wherein the resource allocation for the set of LLR scaling reference signals comprises a two-dimensional grid comprising respective resources in a time domain and a frequency domain based at least in part on the OFDM waveform.
Aspect 16: The method of aspect 15, further comprising: transmitting, based at least in part on the configuration, the set of LLR scaling reference signals in accordance with the two-dimensional grid, wherein a density of the set of LLR scaling reference signals in the two-dimensional grid is based at least in part on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.
Aspect 17: The method of aspects 14, further comprising: determining that the waveform type comprises a DFT-s-OFDM waveform, wherein the resource allocation for the set of LLR scaling reference signals comprises a one-dimensional grid comprising respective resources in a time domain based at least in part on the DFT-s-OFDM waveform.
Aspect 18: The method of aspect 17, further comprising: receiving, based at least in part on the configuration, the set of LLR scaling reference signals in accordance with the one-dimensional grid, wherein a density of the set of LLR scaling reference signals in the time domain is based at least in part on a range of signal-to-noise ratios, a range of modulation and coding schemes, one or more mobility parameters, one or more interference characteristics in the time domain, one or more parameters associated with nonstationary interference, or any combination thereof.
Aspect 19: The method of any of aspects 14 through 18, further comprising: transmitting, based at least in part on the configuration, the set of LLR scaling reference signals, wherein the set of LLR scaling reference signals comprise one or more blocks of LLR scaling reference signals, each block comprising a repetition or concatenation of a respective LLR scaling reference signal, and each block being separated by a time-domain gap or a frequency-domain gap based at least in part on the waveform type.
Aspect 20: The method of any of aspects 14 through 19, further comprising: determining one or more parameters associated with communicating with the wireless device, wherein the configuration of the set of LLR scaling reference signals is based at least in part on the one or more parameters; and transmitting, to the wireless device, one or more messages indicating the one or more parameters.
Aspect 21: The method of aspect 20, wherein the one or more parameters are associated with channel Doppler effects, interference characteristics, a channel flatness, a physical resource group size, or any combination thereof.
Aspect 22: The method of any of aspects 14 through 21, wherein the configuration is indicated for each component carrier of a set of component carriers associated with communication between the wireless device and the UE.
Aspect 23: The method of any of aspects 14 through 22, wherein transmitting the message indicating the configuration comprises: transmitting an RRC message, a MAC-CE, downlink control information, or any combination thereof, indicating the configuration of the set of LLR scaling reference signals.
Aspect 24: A wireless device comprising one or more memories storing processor-executable code, and one or more processors coupled with the one or more memories and individually or collectively operable to execute the code to cause the wireless device to perform a method of any of aspects 1 through 13.
Aspect 25: A wireless device comprising at least one means for performing a method of any of aspects 1 through 13.
Aspect 26: A non-transitory computer-readable medium storing code the code comprising instructions executable by one or more processors to perform a method of any of aspects 1 through 13.
Aspect 27: A UE comprising one or more memories storing processor-executable code, and one or more processors coupled with the one or more memories and individually or collectively operable to execute the code to cause the UE to perform a method of any of aspects 14 through 23.
Aspect 28: A UE comprising at least one means for performing a method of any of aspects 14 through 23.
Aspect 29: A non-transitory computer-readable medium storing code the code comprising instructions executable by one or more processors to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive, from a user equipment (UE), a message indicating a configuration of a set of log-likelihood ratio scaling reference signals, the configuration comprising a resource allocation for the set of log-likelihood ratio scaling reference signals that is based at least in part on a waveform type associated with communications between the UE and the wireless device;
receive, from the UE, one or more pre-equalized data transmissions that include the set of log-likelihood ratio scaling reference signals in accordance with the resource allocation, the one or more pre-equalized data transmissions having the waveform type; and
decode the one or more pre-equalized data transmissions based at least in part on log-likelihood ratio scaling using the set of log-likelihood ratio scaling reference signals.

2. The wireless device of claim 1, wherein the one or more processors are individually or collectively further operable to execute the code to cause the wireless device to:
perform the log-likelihood ratio scaling for the one or more pre-equalized data transmissions, wherein the log-likelihood ratio scaling is different for each resource element per symbol period of the one or more pre-equalized data transmissions, the waveform type of the one or more pre-equalized data transmissions comprising an orthogonal frequency division multiplexing (OFDM) waveform.

3. The wireless device of claim 2, wherein the resource allocation for the set of log-likelihood ratio scaling reference signals comprises a two-dimensional grid comprising respective resources in a time domain and a frequency domain based at least in part on the OFDM waveform.

4. The wireless device of claim 3, wherein the one or more processors are individually or collectively further operable to execute the code to cause the wireless device to:
receive, based at least in part on the configuration, the set of log-likelihood ratio scaling reference signals in accordance with the two-dimensional grid, wherein a density of the set of log-likelihood ratio scaling reference signals in the two-dimensional grid is based at least in part on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

5. The wireless device of claim 1, wherein the one or more processors are individually or collectively further operable to execute the code to cause the wireless device to:
perform the log-likelihood ratio scaling for the one or more pre-equalized data transmissions, wherein the log-likelihood ratio scaling is different for each symbol period of the one or more pre-equalized data transmissions, the waveform type of the one or more pre-equalized data transmissions comprising a discrete Fourier transform-spread-orthogonal frequency division multiplexing (DFT-s-OFDM) waveform.

6. The wireless device of claim 5, wherein the resource allocation for the set of log-likelihood ratio scaling reference signals comprises a one-dimensional grid comprising respective resources in a time domain based at least in part on the DFT-s-OFDM waveform.

7. The wireless device of claim 6, wherein the one or more processors are individually or collectively further operable to execute the code to cause the wireless device to:
receive, based at least in part on the configuration, the set of log-likelihood ratio scaling reference signals in accordance with the one-dimensional grid, wherein a density of the set of log-likelihood ratio scaling reference signals in the time domain is based at least in part on a range of signal-to-noise ratios, a range of modulation and coding schemes, one or more mobility parameters, one or more interference characteristics in the time domain, one or more parameters associated with nonstationary interference, or any combination thereof.

8. The wireless device of claim 1, wherein the set of log-likelihood ratio scaling reference signals comprise one or more subsets of log-likelihood ratio scaling reference signals included in respective groups in accordance with the configuration, the log-likelihood ratio scaling is based at least in part on the respective groups.

9. The wireless device of claim 1, wherein the one or more processors are individually or collectively further operable to execute the code to cause the wireless device to:
receive, based at least in part on the configuration, the set of log-likelihood ratio scaling reference signals, wherein the set of log-likelihood ratio scaling reference signals comprise one or more blocks of log-likelihood ratio scaling reference signals, each block comprising a repetition or concatenation of a respective log-likelihood ratio scaling reference signal, and each block being separated by a time-domain gap or a frequency-domain gap based at least in part on the waveform type.

10. The wireless device of claim 1, wherein the one or more processors are individually or collectively further operable to execute the code to cause the wireless device to:
receive, from the UE, one or more messages indicating one or more parameters associated with communicating with the UE, wherein the configuration of the set of log-likelihood ratio scaling reference signals is based at least in part on the one or more parameters.

11. The wireless device of claim 10, wherein the one or more parameters are associated with channel Doppler effects, interference characteristics, a channel flatness, a physical resource group size, or any combination thereof.

12. The wireless device of claim 1, wherein the configuration is indicated for each component carrier of a set of component carriers associated with communication between the wireless device and the UE.

13. The wireless device of claim 1, wherein, to receive the message indicating the configuration, the one or more processors are individually or collectively operable to execute the code to cause the wireless device to:
receive a radio resource control (RRC) message, a medium access control-control element (MAC-CE), downlink control information, or any combination thereof, indicating the configuration of the set of log-likelihood ratio scaling reference signals.

14. A user equipment (UE), comprising:
one or more memories storing processor-executable code; and
one or more processors coupled with the one or more memories and individually or collectively operable to execute the code to cause the UE to:
transmit, to a wireless device, a message indicating a configuration of a set of log-likelihood ratio scaling reference signals, the configuration comprising a resource allocation for the set of log-likelihood ratio scaling reference signals that is based at least in part on a waveform type associated with communications between the wireless device and the UE; and
transmit, to the wireless device, one or more pre-equalized data transmissions that include the set of log-likelihood ratio scaling reference signals in accordance with the resource allocation, the one or more pre-equalized data transmissions having the waveform type.

15. The UE of claim 14, wherein the one or more processors are individually or collectively further operable to execute the code to cause the UE to:
determine that the waveform type comprises an orthogonal frequency division multiplexing (OFDM) waveform, wherein the resource allocation for the set of log-likelihood ratio scaling reference signals comprises a two-dimensional grid comprising respective resources in a time domain and a frequency domain based at least in part on the OFDM waveform.

16. The UE of claim 15, wherein the one or more processors are individually or collectively further operable to execute the code to cause the UE to:
transmit, based at least in part on the configuration, the set of log-likelihood ratio scaling reference signals in accordance with the two-dimensional grid, wherein a density of the set of log-likelihood ratio scaling reference signals in the two-dimensional grid is based at least in part on a range of signal-to-noise ratios, a range of modulation and coding schemes, one or more mobility parameters, one or more channel types, a physical resource group size, one or more interference characteristics in the frequency domain, one or more interference characteristics in the time domain, one or more parameters associated with nonstationary interference, or any combination thereof.

17. The UE of claim 14, wherein the one or more processors are individually or collectively further operable to execute the code to cause the UE to:
determine that the waveform type comprises a discrete Fourier transform-spread-orthogonal frequency division multiplexing (DFT-s-OFDM) waveform, wherein the resource allocation for the set of log-likelihood ratio scaling reference signals comprises a one-dimensional grid comprising respective resources in a time domain based at least in part on the DFT-s-OFDM waveform.

18. The UE of claim 17, wherein the one or more processors are individually or collectively further operable to execute the code to cause the UE to:
receive, based at least in part on the configuration, the set of log-likelihood ratio scaling reference signals in accordance with the one-dimensional grid, wherein a density of the set of log-likelihood ratio scaling reference signals in the time domain is based at least in part on a range of signal-to-noise ratios, a range of modulation and coding schemes, one or more mobility parameters, one or more interference characteristics in the time domain, one or more parameters associated with nonstationary interference, or any combination thereof.

19. The UE of claim 14, wherein the one or more processors are individually or collectively further operable to execute the code to cause the UE to:
transmit, based at least in part on the configuration, the set of log-likelihood ratio scaling reference signals, wherein the set of log-likelihood ratio scaling reference signals comprise one or more blocks of log-likelihood ratio scaling reference signals, each block comprising a repetition or concatenation of a respective log-likelihood ratio scaling reference signal, and each block being separated by a time-domain gap or a frequency-domain gap based at least in part on the waveform type.

20. The UE of claim 14, wherein the one or more processors are individually or collectively further operable to execute the code to cause the UE to:
determine one or more parameters associated with communicating with the wireless device, wherein the configuration of the set of log-likelihood ratio scaling reference signals is based at least in part on the one or more parameters; and
transmit, to the wireless device, one or more messages indicating the one or more parameters.

21. The UE of claim 20, wherein the one or more parameters are associated with channel Doppler effects, interference characteristics, a channel flatness, a physical resource group size, or any combination thereof.

22. The UE of claim 14, wherein the configuration is indicated for each component carrier of a set of component carriers associated with communication between the wireless device and the UE.

23. The UE of claim 14, wherein, to transmit the message indicating the configuration, the one or more processors are individually or collectively operable to execute the code to cause the UE to:
transmit a radio resource control (RRC) message, a medium access control-control element (MAC-CE), downlink control information, or any combination thereof, indicating the configuration of the set of log-likelihood ratio scaling reference signals.

24. A method for wireless communications by a wireless device, comprising:
receiving, from a user equipment (UE), a message indicating a configuration of a set of log-likelihood ratio scaling reference signals, the configuration comprising a resource allocation for the set of log-likelihood ratio scaling reference signals that is based at least in part on a waveform type associated with communications between the UE and the wireless device;
receiving, from the UE, one or more pre-equalized data transmissions that include the set of log-likelihood ratio scaling reference signals in accordance with the resource allocation, the one or more pre-equalized data transmissions having the waveform type; and
decoding the one or more pre-equalized data transmissions based at least in part on log-likelihood ratio scaling using the set of log-likelihood ratio scaling reference signals.

25. The method of claim 24, further comprising:
performing the log-likelihood ratio scaling for the one or more pre-equalized data transmissions, wherein the log-likelihood ratio scaling is different for each resource element per symbol period of the one or more pre-equalized data transmissions, the waveform type of the one or more pre-equalized data transmissions comprising an orthogonal frequency division multiplexing (OFDM) waveform.

26. The method of claim 25, wherein the resource allocation for the set of log-likelihood ratio scaling reference signals comprises a two-dimensional grid comprising respective resources in a time domain and a frequency domain based at least in part on the OFDM waveform.

27. The method of claim 24, further comprising:
performing the log-likelihood ratio scaling for the one or more pre-equalized data transmissions, wherein the log-likelihood ratio scaling is different for each symbol period of the one or more pre-equalized data transmissions, the waveform type of the one or more pre-equalized data transmissions comprising a discrete Fourier transform-spread-orthogonal frequency division multiplexing (DFT-s-OFDM) waveform.

28. The method of claim 27, wherein the resource allocation for the set of log-likelihood ratio scaling reference signals comprises a one-dimensional grid comprising respective resources in a time domain based at least in part on the DFT-s-OFDM waveform.

29. The method of claim 24, wherein the set of log-likelihood ratio scaling reference signals comprise one or more subsets of log-likelihood ratio scaling reference signals included in respective groups in accordance with the configuration, the log-likelihood ratio scaling is based at least in part on the respective groups.

30. A method for wireless communications by a user equipment (UE), comprising:
transmitting, to a wireless device, a message indicating a configuration of a set of log-likelihood ratio scaling reference signals, the configuration comprising a resource allocation for the set of log-likelihood ratio scaling reference signals that is based at least in part on a waveform type associated with communications between the wireless device and the UE; and
transmitting, to the wireless device, one or more pre-equalized data transmissions that include the set of log-likelihood ratio scaling reference signals in accordance with the resource allocation, the one or more pre-equalized data transmissions having the waveform type.
